(19) United States
(12) Patent Application Publication
(10) Pub. No.: US 2015/0186574 A1
(43) Pub. Date: Jul. 2, 2015

(54) COMPUTING SYSTEMS, TOOLS, AND METHODS FOR SIMULATING WELLBORE ABANDONMENT

(71) Applicant: SMITH INTERNATIONAL, INC., Houston, TX (US)

(72) Inventors: Sujian Huang, Beijing (CN); Xinghan Liu, Beijing (CN); Jianjun Yang, Beijing (CN); Gang Xu, Beijing (CN); Feng Feng, Beijing (CN)

(21) Appl. No.: 14/584,525

(22) Filed: Dec. 29, 2014

Related U.S. Application Data
(60) Provisional application No. 61/922,405, filed on Dec. 31, 2013.
(60) Provisional application No. 62/097,362, filed on Dec. 29, 2014.

(51) Int. Cl. G06F 17/50

(52) U.S. Cl. CPC G06F 17/5018

(57) ABSTRACT

Specialized computing systems, devices, interfaces and methods facilitate the simulation of downhole wellbore abandonment procedures such as section milling and casing milling. Computing systems, devices, interfaces and methods enable a user to design and select BHA components and procedures to be compared and simulated. Various parameters, such as wellbore casing parameters, milling tool parameters, simulation parameters, and the like may be accessed and selectably modified by user input with interactive elements presented at user interfaces to define and control simulations of abandonment procedures. Different types of output are selectably rendered to reflect various aspects of the simulated abandonment procedures.

### CROSS-REFERENCE TO RELATED APPLICATIONS

This application claims the benefit of and priority to U.S. Provisional Patent Application Ser. No. 61/922,405 filed on Dec. 31, 2013, entitled “METHODS FOR ANALYZING AND OPTIMIZING DOWNHOLE MILLING OPERATIONS,” and to United States Provisional Patent Application Serial No. 62/097,362 filed on Dec. 29, 2014, entitled “COMPUTING SYSTEMS, TOOLS, AND METHODS FOR SIMULATING DOWNHOLE OPERATIONS.” This application is also related to U.S. patent application Ser. No. 14/584,424, filed on Dec. 29, 2014, entitled “COMPUTING SYSTEMS, TOOLS, AND METHODS FOR SIMULATING WELLBORE DEPARTURE,” and U.S. patent application Ser. No. 14/584,477, filed Dec. 29, 2014, entitled “COMPUTING SYSTEMS, TOOLS, AND METHODS FOR SIMULATING WELLBORE RE-ENTRY.” Each of the foregoing applications is expressly incorporated herein by reference in its entirety.

### BACKGROUND

Operations, such as geophysical surveying, drilling, milling, logging, well completion, hydraulic fracturing, steam injection, and production, are typically performed to locate and collect valuable subterranean assets. Examples of subterranean assets include fluids (e.g., hydrocarbons such as oil or gas, water, etc.), as well as minerals, and other materials. In some cases, a casing may be installed within a wellbore of a well to improve the structural integrity of the wellbore or to isolate the wellbore from the surrounding formation. The casing may include one or more tubes made of steel. Cement and other materials may be positioned around the circumferential wall of the casing, in an annulus between the casing and the formation, to secure the casing in place within the wellbore.

When it is determined that a well should no longer be used (e.g., after a cost/benefit analysis indicates production has dropped below a cost for running the well), it may be desirable to seal the wellbore to prevent damage to the environment, among other reasons. In some instances, it may be desirable to seal off a selected portion of a wellbore (e.g., deviated boreholes, or sections between or below particular deviated boreholes). A process of sealing a well or selected portions of a wellbore is often referred to as well abandonment.

### SUMMARY

In some embodiments, systems, interfaces, methods, and computer-readable media are operable to simulate wellbore abandonment procedures to predict the effectiveness and outcome of physical wellbore abandonment processes and assemblies and to reflect how different configurations of wellbore abandonment assemblies and process parameters can change performance for different anticipated wellbore abandonment assemblies and procedures.

In some embodiments, simulated wellbore abandonment procedures are performed by one or more computing systems that are configured with one or more processors and specialized interfaces. These computing systems may also include one or more of an interface engine, visualizing engine, or simulation engine. Computer-executable instructions, when executed by the one or more processors and engines, are operable to implement the functionality described herein for analyzing and simulating wellbore abandonment procedures involving different combinations of tools and environments.

In some embodiments, the computing system accesses parameters of a virtual downhole environment and one or more virtual milling tool(s). The computing system also simulates an abandonment procedure that includes a simulated interaction of the virtual milling tool(s) with the virtual downhole environment (e.g., with casing in the virtual downhole environment). Corresponding output associated with the simulated abandonment procedure may then be rendered in one or more different formats or interfaces.

The virtual milling tool may include section mills, casing mills, or other tools that are capable of milling a section of casing within a wellbore, or any other mills or tools that are capable of removing debris and other material from a wellbore (e.g., cement, earth formation, tools, sensors, whipstocks, casing, plugs, etc.). A virtual downhole environment may include any material located in or adjacent to the sections of casing being removed during an abandonment procedure (e.g., additional casing(s), cement layer(s), earth formation(s), tool(s), sensor(s), whipstock(s), fluid(s), etc.).

The computing system may present the virtual milling tool and downhole environment and corresponding parameters (e.g., milling tool parameters, wellbore casing parameters, etc.) at one or more graphical user interfaces. The computing system may also access, select, or modify parameters of the virtual milling tool and parameters of the virtual downhole environment, as well as simulation parameters (i.e., parameters that at least partially control or define an interaction of the virtual milling tool and the virtual downhole environment) in response to user input directed at interactive elements that are presented at the user interfaces.

In some embodiments, the computing system accesses or selects parameters of the virtual milling tool and virtual downhole casing environment. In the same or other embodiments, the computing system may access, receive, or otherwise select simulation parameters input into an interface, or obtained from mesh simulation data defining at least a virtual state of one or more wellbores following a previous simulation of a downhole procedure involving the one or more wellbores.

In some embodiments, the computing system accesses or selects parameters of the virtual milling tool and virtual downhole environment, and/or the simulation parameters from one or more files having defined parameters corresponding to actual field data extracted from one or more sensors or measuring devices.

The computing system may utilize an interface engine to generate an abandonment interface that displays interactive elements that, in response to user input directed at the interactive elements, selects, defines, or modifies one or more of the milling tool parameters or wellbore casing parameters stored in one or more files accessible to the interface engine. Then, in response to receiving user input directed at the interactive elements, the computing system responsively selects, defines, or modifies at least one of the abandonment milling tool parameters or the wellbore casing parameters.

The computing system may utilize a visualizing engine to generate a visual representation of one or more virtual milling tools or one or more virtual wellbore casings associated with the user input, one or more simulations, or the like.

The computing system may utilize an interface engine to select at least one of one or more virtual milling tools, one or more virtual wellbore casings, or one or more abandonment simulation parameters that control or define an action of the one or more virtual milling tools or an interaction between the one or more virtual milling tools and the one or more virtual wellbore casings.

The computing system may utilizes a simulation engine to perform a simulation of an abandonment procedure based on at least a selected one or more of the abandonment simulation parameters, which involves an interaction of the selected one or more virtual milling tools with the selected one or more virtual wellbore casings. The computing system may perform the simulation after identifying the one or more abandonment simulation procedures, the one or more virtual milling tools, and the one or more virtual wellbore casings. The simulation may involve a finite element analysis on one or more of the selected virtual milling tools and virtual wellbore casings.

In some embodiments, a computing system may use one or more engines of a graphical user interface to perform a simulation of an abandonment procedure including a plugging operation. The simulation of the plugging operation may include an interaction between a virtual downhole environment and one or more virtual plugging tools (e.g., a bridge plug, a cement string, etc.). A wellbore abandonment simulation may include simulating a virtual milling procedure and/or a virtual plugging procedure.

The computing system may also utilize one or more simulation interfaces to render one or more outputs associated with the simulation of one or more of the abandonment procedure, the one or more virtual milling tools, the virtual wellbores, the virtual wellbore casings, or the virtual plugging tools. The output(s) may include performance data and other results associated with the simulated abandonment procedure. The output(s) may be rendered at one or more display devices or other output devices. The output(s) may visually reflect at least one of a casing diameter, wellbore diameter, wellbore quality, von Mises stress, vibration, bending moment, milling tool wear rate, casing material removal, cement material removal, earth formation removal, contact force, lateral acceleration, surface torque, mill axial acceleration, rate of penetration, downhole weight-on-bit, downhole rotational speed, plug material quantity, plug cure time, or mill trajectory.

This summary is provided to introduce a selection of concepts that are further described in the figures and the detailed description. This summary is not intended to identify key or essential features, nor is it intended to be used as an aid in limiting the scope of the disclosure, including the claimed subject matter. Additional features of embodiments of the disclosure will be set forth in the description and figures, and in part will be obvious from the disclosure herein, or may be learned by the practice of such embodiments. Features and aspects of such embodiments may be realized and obtained by means of the instruments and combinations particularly pointed out in the appended claims, and otherwise described herein. These and other features will become more fully apparent from the following description and appended claims, or may be learned by the practice of such embodiments.

### BRIEF DESCRIPTION OF THE DRAWINGS

A more particular description will be rendered by reference to specific, example embodiments which are illustrated in the appended drawings. While some of the drawings may be schematic or exaggerated representations of concepts, at least some of the drawings may be drawn to scale. Such scale drawings should be understood to be so scale for some embodiments, but not to scale for other embodiments contemplated herein. Understanding that the drawings depict some example embodiments, the embodiments will be described and explained with additional specificity and detail through the use of the accompanying drawings in which:

FIG. 1-1 is a partial, cross-sectional side view of a general wellbore environment during a wellbore abandonment procedure, in accordance with one or more embodiments of the present disclosure.

FIG. 1-2 is a partial, cross-sectional view of the general wellbore environment of FIG. 1-1 during another wellbore abandonment procedure, in accordance with one or more embodiments of the present disclosure.

FIG. 2 is a cross-sectional view of a wellbore that includes an inner casing, an outer casing, and a cement layer in an annulus between the inner and outer casings, in accordance with one or more embodiments of the present disclosure.

FIG. 3 shows a computing environment that can be used for simulating wellbore abandonment, in accordance with one or more embodiments of the present disclosure.

FIGS. 4-7 show graphical user interfaces for use in a system for simulating wellbore abandonment procedures, in accordance with one or more embodiments of the present disclosure.

FIGS. 8 and 9 show example animation and visualization interfaces for use in a system for simulating wellbore abandonment, in accordance with one or more embodiments of the present disclosure.

FIGS. 10-19 show example simulation output interfaces and performance data for BHA configurations corresponding to one or more simulated wellbore abandonment procedures, in accordance with one or more embodiments of the present disclosure.

FIGS. 20-22 show additional example simulation output interfaces and performance data for BHA configurations corresponding to one or more simulated wellbore abandonment procedures, in accordance with one or more embodiments of the present disclosure.

### DETAILED DESCRIPTION

One or more specific embodiments of the present disclosure are described herein. Some embodiments of the present disclosure relate to methods, systems, interfaces, and computer-readable media for simulating wellbore abandonment procedures including, but not limited to, section milling, casing milling, reaming, plugging, fishing, and other wellbore abandonment procedures. These described embodiments are examples of the presently disclosed techniques. Additionally, in an effort to provide a concise description of these embodiments, not all features of some actual embodiments may be described or illustrated. It should be appreciated that in the development of any such actual embodiments, as in any engineering or design project, numerous embodiment-specific decisions will be made to achieve the developers' specific goals, such as compliance with system-related and business-related constraints, which may vary from one embodiment to another. It should further be appreciated that such a development effort might be complex and time consuming, but would nevertheless be a routine undertaking of design, fabrication, and manufacture for those of ordinary skill having the benefit of this disclosure.

Simulated abandonment procedures according to embodiments of the present disclosure can, in some instances, help in the design, selection, or modification of a BHA for performance of a particular abandonment procedure in less time and/or in a more efficient way than was previously possible. Interfaces and systems of the disclosure may also, in some instances, improve the usability of stored files (e.g., simulation mesh files, data files, etc.) containing parameters associated with wellbore abandonment tools (e.g., section mills, casing mills, hole enlargement tools such as reamers and hole openers, plugs, cement strings, etc.), wellbore environments (e.g., casing(s), cement layer(s), formation, etc.) and corresponding abandonment procedures.

Embodiments of the present disclosure may also, in some embodiments, improve the efficacy of computing systems that are used to identify and design BHAs and BHA components that can be physically manufactured and used in actual abandonment procedures, through at least performing the simulations of the abandonment procedures described herein. For example, by making simulated predictions of defined abandonment procedures, which are performed by defined BHA assemblies, it can be possible to compare and identify assemblies and procedures that can be utilized to reduce costs and increase efficiency when performing actual, field abandonment procedures, such as section milling, casing milling, hole enlargement, fishing, plugging, and other abandonment procedures.

Most of the terms used herein will be recognizable to those of skill in the art. In certain instances, however, terms may be explicitly defined. Any terms not explicitly defined should be interpreted as adopting a meaning presently accepted by those skilled in the art.

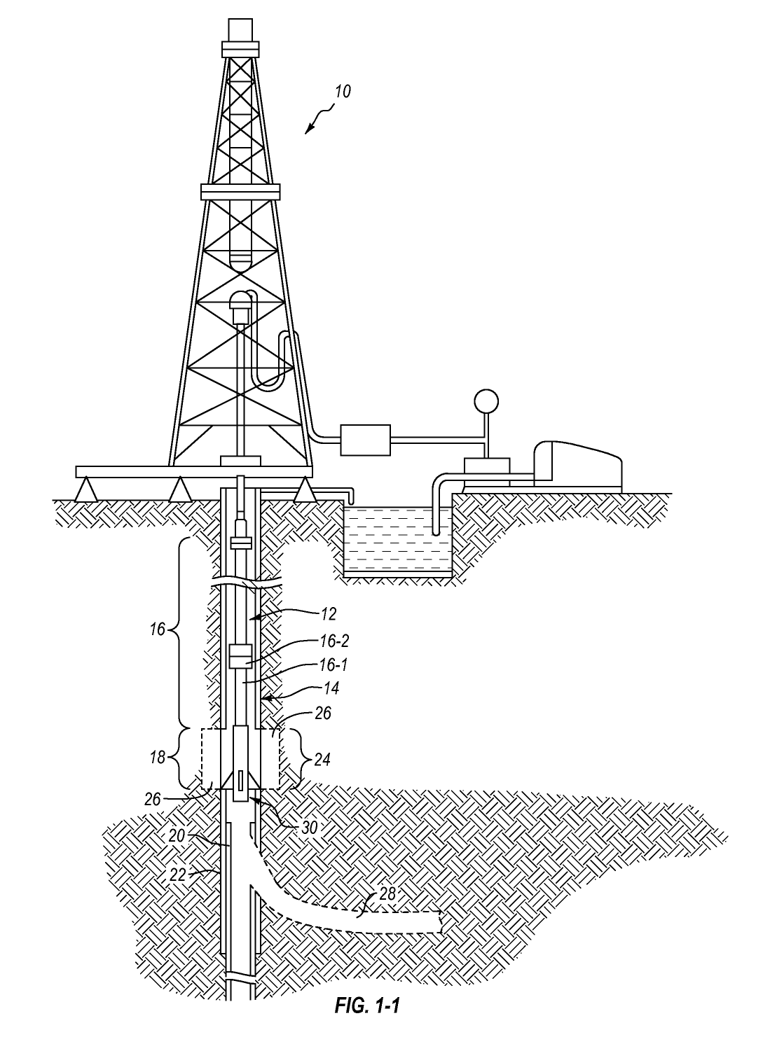

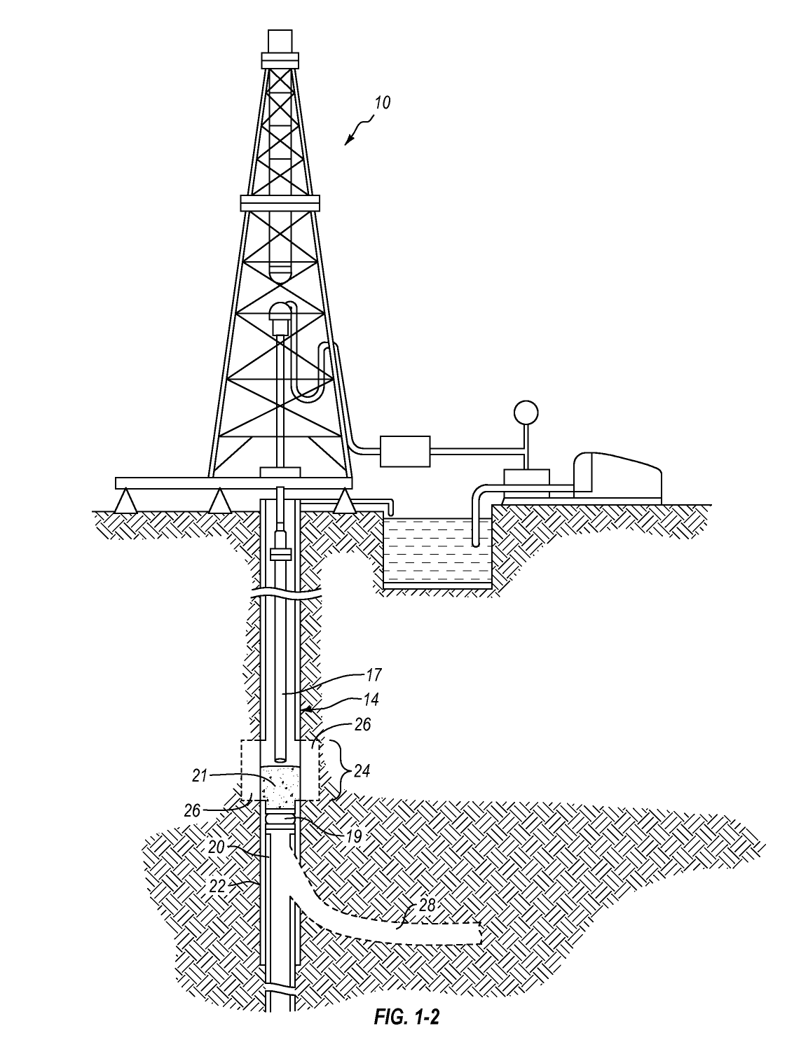

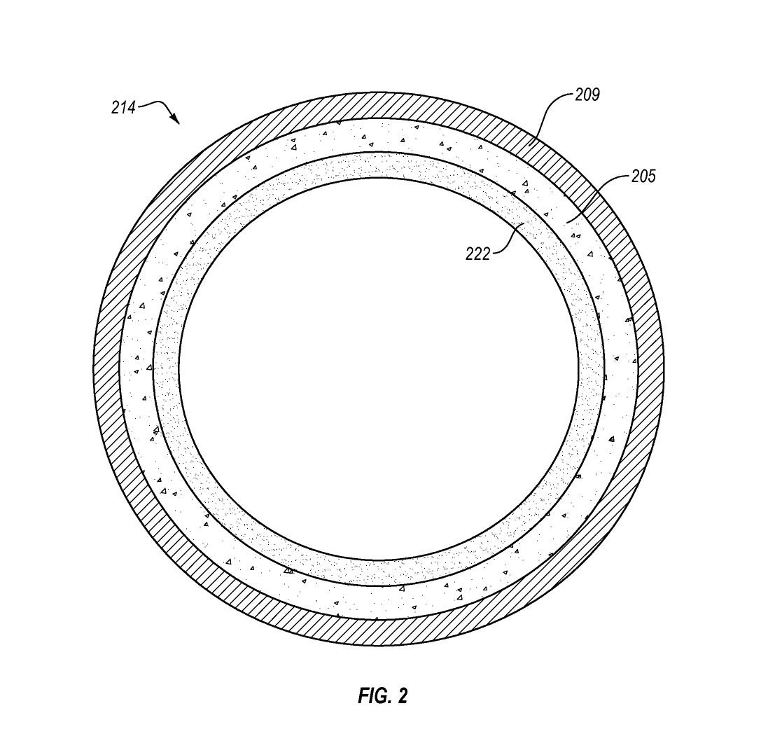

FIGS. 1-1 and 1-2 show examples of a downhole system for performing downhole procedures within an earth formation. The downhole system of FIGS. 1-1 and 1-2 include a drilling rig 10 which may be used to turn a downhole tool assembly 12 that extends downward into a wellbore 14. The downhole tool assembly 12 may include a drill string 16 and a bottomhole assembly (BHA) 18 coupled to a downhole end portion of the drill string 16. As will be appreciated by one having ordinary skill in the art, the downhole end portion of the drill string 16 may be a portion furthest from the drilling rig 10 and/or the surface of the wellbore 14.

The drill string 16 may include several joints of drill pipe 16-1 connected end-to-end through tool joints 16-2. The drill string 16 may be used to transmit drilling fluid (e.g., through its hollow core) and/or to transmit rotational power from the drill rig 10 to the BHA 18. In some cases, the drill string 16 may further include additional components such as subs, pup joints, etc. In some embodiments, the drill string 16 may include a single or extended string component (e.g., coiled tubing). Optionally, the rotational power for rotating the BHA 18 may be provided by one or more downhole components (e.g., turbine motor, mud motor, etc.).

The drill string 16 may also have, in some embodiments, a mill (e.g., a section mill or casing mill) that is specifically designed to mill through one or more casings linking the inner wall of the wellbore 14. The lining may include a single casing, or a plurality of casings. In FIG. 1-1, for instance, the wellbore 14 may have a lining that includes one or more inner casings 20 and one or more outer casings 22. In this embodiment, the inner casing 20 is shown as a liner suspended from the outer casing 22; however, it should be appreciated that the inner and outer casings 20 and 22 may have any number of arrangements. For instance, the inner casing could extend fully to surface.

The BHA 18 may be used to mill into (and potentially radially through) a portion of the casings 20 and 22 within the wellbore 14. In some embodiments, the BHA 18 may be used to mill a single casing (e.g., inner casing 20). In other embodiments, the BHA 18 may be used to mill multiple casings (e.g., casings 20 and 22). In operation, the mill may include blades that extend radially outward from a tool body to initiate a cutout into the casing. As the BHA 18 is rotated, the cutout may be formed circumferentially around the casing. The BHA 18 may be moved axially while milling to also mill an axial section of the casing. When the BHA 18 mills radially through a full thickness of the casing 20 and/or 22, the BHA 18 may also mill cement outside the casings 20 and 22. In some embodiments, the BHA 18 may mill or otherwise cut into the formation surrounding the wellbore 14, such as, for example, to remove earth formations identified at sections 26. A single tool or multiple tools on the BHA 18 may mill the casing(s) 20 and 22 and/or remove the sections 26. In some embodiments, for instance, one section mill may mill both casings 20 and 22. In other embodiments, different section mills may mill each of casing 20 and casing 22. One or both section mills (or other milling tools) may remove the sections 26; however, in still another embodiment, a reamer or other hole enlargement device may remove at least a portion of the sections 26.

Sometimes, one or more deviated boreholes 28 may have also been drilled off of the wellbore 14. Occasionally, it is desired to seal the wellbore 14 or one or more boreholes 28. To create a seal, it may be helpful to ensure that the seal extends from rock-to-rock, or is in direct contact with the formation (e.g., for a cement plug). Where the wellbore 14 has one or more casings the BHA 18 may mill the casings 20 and/or 22, cement, or formation as desired to ensure enough material has been removed to allow a plug (e.g., a cement plug) to be set at least partially in direct contact with the formation. The process of milling away the material in and around the desired location for a plug is one example of an abandonment procedure. The material that may be removed includes casing material (including liner material), cement material, tool material, sensors, and other debris. In some embodiments, an abandonment procedure may include other or additional operations. By way of illustration, other abandonment procedures may include hole enlargement (e.g., reaming), wellbore isolation (e.g., installation of a bridge plug), cementing, other procedures, or combinations of the foregoing. In FIG. 1-2, for instance, the BHA 18 has been removed and replaced with a cementing string 17. A plug 19 (e.g., a bridge plug) may be installed in the casing(s) 20 and/or 22 to isolate an upper portion of the wellbore 14 from a lower portion of the wellbore 14. The cementing string 17 may then pump cement into the wellbore 14 to form a cement plug 21 in the upper portion of the wellbore 14. As shown in FIG. 1-2, the plug 21 may be formed at least partially within the section milled or other abandonment and plugging (P&A) section of the wellbore 14. In at least some embodiments, the plug 21 may extend axially above and/or below the P&A section of the wellbore 14.

It should be appreciated in view of the disclosure herein that the plug 21 in FIG. 1-2 is merely illustrative. In other embodiments, for instance, the plug 21 may be formed at a downhole end portion of the wellbore 14 and a plug 19 may or may not be used. In other embodiments, the plug 21 (and optionally plug 19) may be formed in the deviated borehole 28.

In some embodiments, a cutting tool 30 of the BHA 18 can be a bit or other type of mill specifically configured for metal cutting (e.g., a section mill tool with expandable blades, a lead mill, a taper mill, a casing mill with fixed blades, a dress mill, a follow mill, or any other milling tool that is configured for milling through the casing(s) 20 and/or 22). The cutting tool 30 can include one or more cutting elements (e.g., polycrystalline diamond compacts, cubic boron nitride cutters, metal carbide cutters (e.g., tungsten carbide cutters), chunky carbide hardfacing, impregnated diamond, roller cone teeth, or other specially manufactured cutters, teeth, or other cutting elements).

In some embodiments, the cutting tool 30 may be a bit configured to mill or drill through concrete or subterranean formation. The cutting tool 30 can also be replaced or supplemented with a hole enlargement tool configured to expand a diameter of a wellbore segment. In some embodiments, the hole enlargement tool may be selectively expandable (e.g., a reamer) while in other embodiments the hole enlargement tool may have a fixed diameter (e.g., a hole opener).

To mill/drill through the structures of a wellbore or subterranean formation, sufficient rotational moment, radial, and axial force is applied to the BHA 18 to cause the cutting tools, bits, or other corresponding cutting elements to cut into the casing, cement, rock, debris, or other materials during rotation of the cutting tool(s).

The axial force applied on the cutting tool 30 (for a mill, a reamer, or any other tool component) may be referred to as “weight-on-bit” (WOB). The rotational moment applied to the downhole tool assembly 12 at the drill rig 10 (e.g., by a rotary table or a top drive mechanism) or using a downhole motor to turn the downhole tool assembly 12 may be referred to as the “rotary torque.” Additionally, the speed at which the rotary table or other device rotates the downhole tool assembly 12, measured in revolutions per minute (RPM), may be referred to as the “rotary speed.” The weight on bit (WOB), rotary speed and other factors (e.g., torque, casing thickness, casing material, type of cutting tool, etc.) may affect the rate at which the P&A section (including one or more casing layer(s), cement layer(s) and earth formation) is milled, drilled, cut, or resized, the quality of the P&A section, the rate of wear on the cutting tool, and the like.

During a wellbore abandonment procedure—including milling, fishing, hole enlargement, plugging (e.g., installation of bridge plug, cement plug formation, etc.—the BHA assembly can be subjected to various vibrations resulting from the different forces at play. These vibrations, which can include any combination of torsional, axial, or lateral vibrations, can have a very detrimental effect on the abandonment procedure and the overall integrity of the cutting tools and other BHA components. In some instances, the vibrations and forces involved can result in off-centered milling/drilling, slower rates of penetration, excessive wear of the cutting elements, premature failure of the milling/drilling components, over gage milling/drilling, and out-of-round milling/drilling.

When a cutting tool wears out or breaks during an abandonment or other downhole operation, the entire BHA is often lifted out of the wellbore, section-by-section, and disassembled to replace the broken components. Because the length of a BHA and drill string may extend for more than a mile, trips can take hours to complete and can pose a significant expense to the wellbore operator. Broken components may also be left downhole in some cases, complicating subsequent procedures.

The BHA 18 may also include additional or other components coupled to the drill string 16 (e.g., between the drill string 16 and the cutting tool 30). Example additional or other BHA components may include drill pipe, drill collars, transition drill pipe (e.g., heavy weight drill pipe), stabilizers (e.g., fixed and/or expandable stabilizers), measurement-while-drilling (MWD) tools, logging-while-drilling (LWD) tools, subs (e.g., shock subs, circulation subs, disconnect subs, cementing subs, etc.), hole enlargement devices (e.g., hole openers, reamers, etc.), jars, thrusters, downhole motors (e.g., turbines and mud motors), rotary steerable systems, vibration dampening tools, vibration inducing tools (e.g., axial, torsional, or lateral), cross-overs, mills (e.g., follow mills, dress mills, watermelon mills, taper mills, drill-mills, junk mills, section mills, rotary steerable mills, casing mills, etc.), rock drills, cement drills, other drills and other BHA tools.

As discussed herein, a wellbore may be lined with one or more casings, such as casings 20 and 22, which each may include a pipe or other tubular element that is lowered into the wellbore 14. The casings 20 and 22 may also be cemented into place. The cement may surround the entirety of each casing or only a portion of the casing(s). The casing(s) may be formed from a high strength material such as stainless steel, aluminum, titanium, fiberglass, other materials, or some combination of the foregoing. Optionally, the casing(s) may include a number of couplings and/or collars that connect a number of casing sections, or pipes, to one another. A series of connected casings is known as a casing string.

A plurality of different casings can also be at least partially nested within one another (e.g., a portion of the length of the casing 20 being nested within casing 22, see also FIG. 2 in which casing 222 is nested within casing 209). In some embodiments, a cement layer may be positioned between layers of nested casings, such as cement layer 205 in FIG. 2 is positioned between casings 209 and 222. The term “casing” is intended to encompass casing which extends from the surface to a downhole location, as well as liners which do not extend fully to surface (e.g. liner suspended from or otherwise coupled to an upper casing or liner through use of a liner hanger).

Some examples of abandonment procedures include milling operations or procedures for milling through one or more casing layers and/or cement surrounding the casing layer(s) to create an open section where a plug can be formed or otherwise positioned. This may include milling or grinding up pre-existing plugs, fish, or other downhole tools, or section milling or casing milling to remove entire sections of casing. Abandonment procedures may also include reaming, hole opening, or other hole enlargement operations to increase a diameter of a portion of a wellbore (optionally a portion of a wellbore where casing has been at least partially milled away). Isolation of a portion of a wellbore (e.g., using a bridge plug) may also be included in some abandonment procedures.

In some instances, wellbore abandonment procedures, may be performed with a cutting tool 30 (e.g., mill, reamer, hole opener, etc.) that includes a plurality of individual blades coupled to a body. The body may be coupled to an end of a drill string in a BHA. The blades may rotate about an axis extending longitudinally through the center of the body and potentially the drill string. The blades may include cutting elements having cutting surfaces. One or more nozzles in the blades or the body may facilitate the circulation of fluid in the wellbore 14 during an abandonment operation. The blades may be fixed or selectively expandable.

Some examples of mills that can be utilized in BHAs and abandonment milling procedures include section mills, pilot mills, tapered mills, junk mills, cement mills, dress mills, follow mills, watermelon mills, drill-mills, rotary steerable mills, casing mills, and so forth. In some embodiments, multiple mills may be used on the same or different BHA during a wellbore abandonment procedure. Other cutting tools (e.g., drill bits, hole enlargement tools, etc.) may also be used on the same or a different BHA during a wellbore abandonment procedure.

Some aspects of the present disclosure provide systems and methods for selecting, modifying, and analyzing the performance of different BHAs and BHA components (e.g., milling tools, plugging tools/materials, etc.) used in abandonment procedures to determine the performance of the different BHA assemblies and/or the possibility, probability, or degree of success or failure for the different BHA assemblies and components during anticipated abandonment procedures.

Some embodiments also include providing systems and methods for analyzing the performance of different BHAs against pre-selected criteria, against one another, against data acquired in the field, against other data, or against any combination of the foregoing. Such analysis may allow, for instance, different BHAs to be compared even before entering the wellbore to determine which milling/abandonment BHA will provide greater rate of penetration, reduced wear or risk or failure, and the like. Such analysis may also allow, for instance, performance data of simulated/virtual milling tools to be compared against field results of corresponding milling tools in a physical wellbore, thereby allowing the simulation system to be calibrated to improve accuracy of subsequent simulations.

Some embodiments disclosed herein may improve an ability of a system user (e.g., an engineer) to optimize the build of a BHA for an abandonment procedure and a plan for a particular abandonment procedure by enabling the user to efficiently interface with a simulation interface that is capable of any one or more of accessing, selecting, or modifying different parameters associated with an anticipated abandonment procedure, including simulation parameters, milling tool parameters, wellbore casing parameters, plug parameters, BHA parameters, and so forth. For sake of clarity, a number of definitions are provided below.

“Wellbore casing parameters” define one or more actual and/or virtual wellbore casings or casing environments and may include one or more dimensions or other parameters associated with a casing, including diameter, length, and thickness, as well as material properties of the corresponding casing (e.g., type, structure, weight, hardness, and material composition) for any or all sections of the corresponding casing. Wellbore casing parameters may also define a depth or axial location of the casing within a wellbore, type and geometry of casing couplings, a quantity of nested casings, or radial spacing between nested casings. In some instances, the properties and characteristics of a cement layer positioned between casings and/or between a casing and the surrounding earth formation can also be defined by wellbore casing parameters. Optionally characteristics and spacing between the wellbore wall and the outer circumference of the cement or casing may be defined by the wellbore casing parameters.

In some embodiments, wellbore casing parameters may be included in, or be associated with, a file including data obtained from a physical test. For instance, a cutting element in a test set-up may be physically scraped against samples of different casing materials (e.g., different types of steel or other metals for casings, liners, couplings, etc.). The cutting element may follow a circular or arcuate path while scraping the material sample, while in other embodiments the physical data may be obtained from a linear scrape test. Optionally, the linear scrape test may be performed at a higher speed than a rotational scrape test used for measuring properties of different rock or formation materials. In the rotational or linear scrape test, the test set-up may measure properties such as forces on the cutting element, volume of material removed, and the like. For instance, the cutting force and/or axial force may be measured during the test and stored in a file as a wellbore casing parameter. Similarly, the volume of material removed per distance over time may be measured. The wear rate of the cutting element may also be measured and/or correlated with the data on volume of material removed. Corresponding data may be obtained for various different axial forces applied on the cutting element. Example data that may be collected and/or stored is described in U.S. Pat. No. 8,185,366, which is incorporated herein by this reference in its entirety.

“Wellbore parameters” may include the geometry of a wellbore and/or the formation's material properties (i.e., rock profiles and other geologic characteristics). Wellbore parameters also include the characteristics and path or trajectory of a wellbore in which a downhole tool assembly may be confined, along with an initial wellbore bottom surface geometry. A wellbore trajectory may be straight, curved, or include a combination of straight and curved sections. As a result, wellbore path, in general, may be defined by defining parameters for each segment of the path. For example, a wellbore may be defined as having N segments characterized by the length, diameter, eccentricity/shape, inclination angle, and azimuth direction of each segment and an indication of the order of the segments (e.g., first, second, etc.). Wellbore parameters defined in this manner may then be used to mathematically produce a model of a path of an entire wellbore, or of the entire portion of the wellbore to be evaluated. Formation material properties at various depths along the wellbore may also be defined and used, including rock profiles and any other characteristics defining aspects of the subterranean formation surrounding the wellbore (e.g., material type, hardness, formation type, etc.). In this regard, wellbore parameters can include or be referred to, in some instances, as “formation parameters.” Wellbore casing parameters may be considered wellbore parameters in some embodiments of the present disclosure. Where a wellbore includes casing, the wellbore casing environment may include both the casing(s) and the surrounding formation.

In some embodiments, formation parameters may be included in, or be associated with, a file including data obtained from a physical test. For instance, a cutting element in a test set-up may be physically scraped against samples of different rock or other formation materials. The cutting element may follow a circular or arcuate path while scraping the material sample, while in other embodiments the physical data may be obtained from a linear scrape test. In the rotational or linear scrape test, the test set-up may measure properties such as forces on the cutting element, volume of material removed, and the like. For instance, the cutting force and/or axial force may be measured during the test and stored in a file as a formation parameter. Similarly, the volume of material removed per distance over time may be measured. The wear rate of the cutting element may also be measured and/or correlated with the data on volume of material removed. Corresponding data may be obtained for various different axial forces applied on the cutting element. Example data that may be collected and/or stored is described in U.S. Pat. No. 8,185,366, which was previously incorporated herein by this reference in its entirety.

Wellbore parameters may also include dip angle (i.e., the magnitude of the inclination of the formation from horizontal) and strike angle (i.e., the azimuth of the intersection of a plane with a horizontal surface) of the wellbore. One of ordinary skill in the art will appreciate in view of the disclosure herein that wellbore parameters may include additional properties, such as friction of the walls of the wellbore (e.g., formation or casing), casing and cement properties, and wellbore fluid properties, among others, without departing from the scope of the disclosure.

Wellbore parameters may also include other parameters, such as plug parameters and fish parameters. Plug parameters may include parameters associated with a plug installed (or to be installed) in a wellbore. Example plugs may include cement plugs, bridge plugs, frac plugs, and the like. In some embodiments, plug parameters may include the type, number, and location of different plugs. Fish parameters may include parameters associated with downhole tools, debris, or other fish within a wellbore.

“Milling tool parameters” define one or more actual and/or virtual milling tools (e.g., virtual mills or other cutting tools or virtual BHA components used in a simulated abandonment procedure) and may include one or more of: mill type; size of mill; shape of mill; blade geometry; blade position; number of blades; blade type; nozzle number; nozzle locations; nozzle orientation; type of cutting structures on the mill; cutting element geometry; number of cutting structures; or location of cutting structures. As with other components in a milling tool assembly, the material properties of the mill (including the mill body, the blades, and the cutting elements on the blades) may be defined for use in analyzing a mill and a milling tool assembly. Milling tool parameters can also include material properties used in designing or analyzing a milling tool, for example, the strength, elasticity, and density of the material used in forming the milling tool, as well as any other configuration or material property of the milling tool, without departing from the scope of the disclosure. Corresponding parameters for hole enlargement tools, fishing tools, and the like can also be included within the milling tool parameters.

Milling tool parameters may be included within a set of “BHA parameters,” which may also include any combination of one or more of the following: a type, location, or quantity of mills, bits or other components included in a BHA used for an abandonment procedure; the length, internal diameter of components, outer diameter of components, weight, or material properties of each component; the type, size, weight, configuration, or material properties of the tool assembly; or the type, size, number, location, orientation, or material properties of cutting elements on the milling/abandonment tools.

“Bit parameters,” which may also be included in the milling tool parameters, correspond to one or more bits or cutting tools used in a BHA and can define any characteristic(s) of the one or more bits or other cutting tools. Parameters related to drill bits, mill bits, milling tools (e.g., section mill, casing mill, etc.), hole enlargement tools (e.g., reamer, hole opener, etc.), fishing spears, and the like should all be considered as within the scope of the bit parameters.

“Simulation parameters,” which are also referred to as “operating parameters,” may include any parameters that are used to control a simulation of an abandonment procedure by at least controlling or defining an action or interaction of one or more virtual milling tools, virtual hole enlargement tools, isolation/plugging tools, or the like. The interaction may be with a virtual wellbore casing or a virtual wellbore. The simulation parameters may include one or more of: rotary torque and/or fluid flow rate, as well as the total number of revolutions to be simulated, the total distance to be milled/cut, the total operating time desired for the simulation, the trajectory of a downhole operation, surface rotational speed; the downhole motor rotational speed (if a downhole motor is included); the hook load; or the weight-on-bit, other related parameters, or any combination of the foregoing Simulation parameters may further include fluid parameters, such as the type of the drilling/milling fluid, and the viscosity and density of the fluid, for example.

The simulations of abandonment procedures may be referred to herein as being “dynamic” because the abandonment procedure is a “transient time simulation,” meaning that it is based on time or the incremental rotation of the virtual milling tool. For the purposes of calibrating a model and having a baseline for potential solutions, a simulation of an abandonment procedure using any of the foregoing parameters may be used. The abandonment simulation may be performed with finite element analysis and other simulation algorithms. In some embodiments, the finite element analysis may use parameters defined, selected, or otherwise modified at a user interface, parameters accessed through one or more files (e.g., formation, casing, fish, milling tool, or other parameters obtained from a scrape test, etc.).

Simulation parameters may also define metrics associated with wellbore abandonment simulations, including but not limited to a quantity and type of outputs to render at any particular time(s). In some embodiments, the simulation parameters may include additional types of parameters or components used to define performance of a simulated abandonment procedure.

Performance of a simulated abandonment procedure may be measured by one or more “performance parameters,” examples of which may include: rate of penetration (ROP); resulting casing width or thickness, material removed, material remaining, rotary torque; rotary speed; lateral, axial, or torsional vibrations and accelerations; weight-on-bit (WOB); forces acting on components of the tools; or forces acting on the components of the tools (e.g., on blades and/or cutting elements). Performance parameters may also include the inclination angle and azimuth direction, trajectory; drill string deformation; cutting tool deformation, walk rate or walking tendency; bending moment; von Mises stress; or tool geometry. One skilled in the art will appreciate, in view of the present disclosure, that other performance parameters related to abandonment, plugging, or other downhole operations (e.g., slot recovery) exist and may be considered without departing from the scope of the disclosure. For instance, quantity of plugging material used, cure time, seal quality, or other performance parameters may be generated for a plugging operation. Additionally, while embodiments of the present disclosure relate to abandonment of a cased wellbore using a section milling or casing milling procedure, use of a casing cutter and casing puller may simulated for a casing cutting and pulling operation.

In one or more embodiments, performance parameters may be rendered as visual outputs or other indicia. Further, the outputs may include tabular data and may be in the form of one or more of graphs, charts, or logs of a performance parameter, with respect to time, or with respect to location along the BHA, for example. When the outputs are given based on location along the BHA, the outputs may be presented as an average value for each location, or by using relative percentages.

Other outputs and plots, in some embodiments, include presentations or visualizations of the results at a minimum or maximum value, at a given location, over a period of time, or any combination of those results. Graphical visualizations of a cutting tool, drill string, hole enlargement tools, milling tools and assemblies, casings plugs, and other wellbore environmental components, may also be output. Graphical visualizations in 2-D, 3-D, or 4-D may include color schemes for any BHA (or BHA components) to indicate performance parameters at different locations on the corresponding component or at different instances in time for a given simulated procedure.

Outputs, in some embodiments, also include animations composed of a plurality of images sequenced together or that overlap. Animations can be run in real-time during simulation processing. Animations can also be rendered after the simulation processing and analysis is complete.

In some instances, simulation outputs also include aural output that may amplify or complement corresponding visual output. The aural output may also correspond with real-world sounds that are typically associated with different downhole processes (e.g., scraping, grinding, tearing, seizing, and so forth) and correspondingly different sounds of cutting different materials (e.g., casing wall, cement, rock, and so forth). In the same or other embodiments, the simulation outputs include haptic feedback that may further complement other simulated output.

In a broad context, the term “abandonment components” can refer to any combination of the aforementioned components and parameters associated with abandonment (including plugging/isolation) procedures that are utilized by the systems, storage devices, methods, and interfaces of the disclosure provided herein.

The parameters that are considered during a simulation analysis can be accessed and input in different ways. In some embodiments, the parameters are accessed from one or more stored files, such as tool files, wellbore casing files, simulation parameter files, rock/formation files, simulation mesh files, BHA files, and so forth. In other instances, a single file may contain a collection of one or more of the aforementioned different types of parameters.

In some embodiments, parameters are entered, defined, or otherwise modified manually through one or more simulation interfaces. In the same or other embodiments, parameters are obtained from actual field data or sensors associated with one or more BHA components, as described herein. The field data can, in some instances, be obtained before, during, or after a simulation. For instance, field data can be obtained prior to a simulation and considered in real-time during the simulation to compare against, calibrate, or tune simulations to attempt to match actual field data.

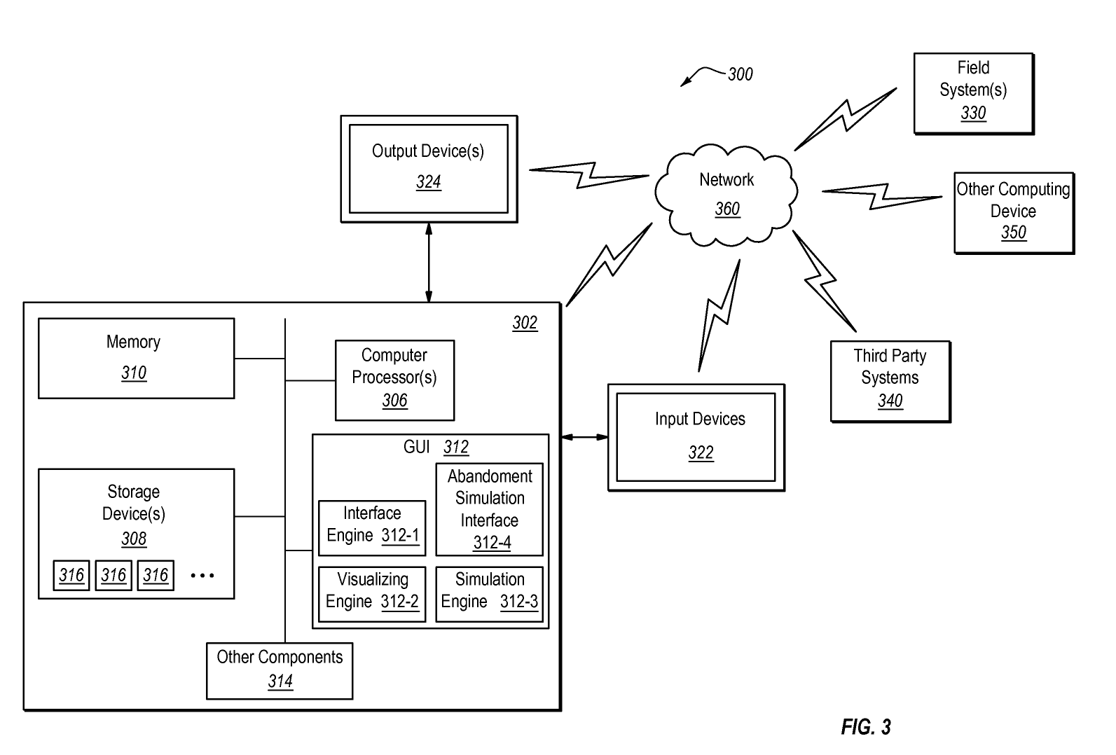

Attention will now be directed to FIG. 3, which schematically depicts a computing system 300 which may be used for accessing, selecting, or modifying the aforementioned parameters, or for performing any combination of the foregoing. The computing system 300 may be used to perform other functionality described herein for facilitating at least the simulation of one or more abandonment procedures. It will be noted, however, that the illustrated embodiment of FIG. 3 is merely an example embodiment, such that the illustrated elements may be omitted, repeated, substituted, or combined with one or more other elements, in some embodiments, without departing from the scope of the present disclosure.

The illustrated computing system 300 of FIG. 3 includes a computing device 302 having one or more computing processors 306 (e.g., a central processing unit (CPU), a graphics processing unit (GPU), and other hardware processors), one or more storage devices 308 (e.g., a hard disk, an optical drive such as a compact disk (CD) drive or digital versatile disk (DVD) drive, a flash or solid state drive or storage device, and/or other hardware storage devices), memory 310 (e.g., random access memory (RAM), read only memory (ROM), cache memory, flash memory, etc.), a graphical user interface (GUI) 312, and other components 314 (e.g., graphics cards, network interface cards (NICs), communication bus, etc.).

In some embodiments, the computing processor(s) 306 may include integrated circuits for processing or executing computer-executable instructions that are stored in the storage device(s) 308 or memory 310 for implementing the methods and functionality disclosed herein. These processor(s) may include one or more core processor(s) and/or micro-core processor(s).

The storage device(s) 308 (and/or any information stored therein) may include a data store such as a database, a file system and/or one or more data structures (e.g., arrays, link lists, tables, hierarchical data structures, relational data structures, etc.) which are configured for computer storage. The data may be stored in any suitable format (e.g., as an extensible markup language (XML) file, a standard generalized markup language (SGML) file, hypertext markup language (HTML) file, or any other suitable storage format).

The storage device(s) 308 may include one or more devices internal to the computing device 302 and/or one or more external storage devices operatively connected to the computing device 302 (e.g., via a port, connector, network interface, etc.).

In some instances, the storage device(s) 308 store one or more files 316. The files 316 may include files as discussed herein, and in some embodiments may contain one or more of milling tool parameters, BHA parameters, wellbore casing parameters, wellbore parameters, simulation parameters, or image data corresponding to graphical representations of at least casings, wellbores, and milling tools, as well as other user interface images. In at least this regard, the wellbore casings, BHA assemblies, and milling tools described herein can also be referred to as virtual wellbore casings, virtual BHAs, and virtual milling tools.

The stored data can be stored separately in the storage device(s) 308 as separate files 316 or together as one or more composite files. The stored files 316 can also include files storing simulation parameters that control how a simulation is run (e.g., algorithms to be applied, simulation iterations, simulation comparisons, simulation inputs and outputs, and so forth). Actual simulation data can also be stored in the storage device(s) 308. Actual field result data can also be stored in the storage device(s) 308.

The GUI 312 may include various specialized computing engines for facilitating the methods and functionality disclosed herein. These specialized computing engines may include, for example, an interface engine 312-1, a visualizing engine 312-2, and a simulation engine 312-3. These engines may be instantiated and/or implemented by the computer processor(s) 306.

The interface engine 312-1 is usable to access (e.g., obtain data from and/or store data to) one or more of the files 316 containing any of the parameters discussed herein, as well as to generate an abandonment simulation interface 312-4 that displays interactive elements that are operable (e.g., in response to user input or automated processing) for selecting the aforementioned parameters in response to user input directed at the interactive elements. Selection of parameters may include accessing stored parameters, receiving new input, accessing previous simulation data, or the like. The GUI 312 may include any combination of display objects such as buttons (e.g., radio buttons, link buttons, etc.), data fields (e.g., input fields), banners, menus (e.g., user input menus), boxes (e.g., input or output text boxes), tables (e.g., data summary tables), sections (e.g., informational sections or sections capable of minimizing/maximizing), screens (e.g., welcome screen, home screen, data screen, login/logged out screen), user selection menus (e.g., drop down menus), or other components, or some combination of the foregoing.

In the same or other embodiments, the GUI 312 may include one or more separate interfaces and may be usable in a web browser as a service and/or as a standalone application. The GUI 312 may include program code or other modules (e.g., stored in storage device(s) 308 and/or memory 310) that may be executed by the computer processor(s) 306 to provide interfaces for input and/or output by a user.

The visualizing engine 312-2 is usable to generate a visual representation of actual or virtual milling tool(s), wellbore casing(s), other BHA component(s), or portions of downhole environments, operation data, or any combination of the foregoing. In some embodiments, the visual representations accurately reflect milling tools and wellbore components or other aspects of the downhole environment based on the aforementioned parameters that were accessed, modified, or otherwise selected. The components can be visualized separately and/or in an assembly by the abandonment simulation interface 312-4.

In accordance with some embodiments, the GUI 312 may be operated by a user (e.g., an engineer, a designer, an operator, an employee, or any other entity) using one or more input devices 322, and the GUI 312 may be visualized using one or more output devices 324 coupled to the computing device 302. The GUI 312 may also access and display data stored in the storage device(s) 308 or memory 310, as well as output that is generated as a result of the simulations.

The input device(s) 322 may include any number of components. For instance, the input device(s) 322 may include any combination of touchscreen, keyboard, mouse, microphone, touchpad, electronic pen, field sensor, camera, or other types of input device.

The output device(s) 324 may also include number of components. For instance, the output device(s) 324 may include any combination of one or more screens or other displays (e.g., a liquid crystal display (LCD), plasma display, light emitting diode (LED) display, touchscreen, cathode ray tube (CRT) monitor, projector, 2D display, 3D display, or other display device), a printer, speaker, haptic feedback device, external storage, or other output devices.

One or more of the output device(s) 324 may be the same or different from the input device(s) 322. The input and output device(s) 322, 324 may be locally or remotely connected to the computer device 302 through wired and/or wireless connections.

In some embodiments, the computing system 300 may also include one or more remote computing devices or systems. These remote devices and systems can include sensor and field systems 330 that are monitoring or that are otherwise connected to a BHA being used in the field, and/or one or more third party systems 340, such as clearinghouse systems or remote databases containing stored data accessed by the computing device 302 to perform one or more of the disclosed functions.

While the computing device 302 is shown as a single device, it will be appreciated that in other embodiments, the computing device 302 is actually a distributed computing system that includes the computing device 302 and one or more other computing devices 350 that each have their own hardware processor(s). In such a distributed computing environment (such as a cloud computing environment), the different computing components (e.g., memory 310, storage device(s) 308, GUI 312, and other components 314) can be shared and/or distributed in any way among the plurality of different computing devices 350.

The computing device 302 may be communicatively coupled to any combination of the foregoing computing systems and devices through a network 360 (e.g., a local area network (LAN), a wide area network (WAN) such as the Internet, mobile network, or any other type of network) through one or more network interfaces that include any combination of one or more wires, cables, fibers, optical connectors, wireless connections, network interface connections, or other network connections.

The aforementioned computing devices and systems may take various forms and configurations, including, physical servers, virtual servers, supercomputers, personal computers, desktop computers, laptop computers, message processors, hand-held devices, programmable logic machines, multi-processor systems, microprocessor-based or programmable consumer electronics, network PCs, tablet computing devices, minicomputers, mainframe computers, mobile telephones, PDAs, wearable computing devices, and the like.

In some embodiments, the computing device 302 and corresponding computing system 300 may be used to simulate an abandonment procedure performed by a virtual BHA and a virtual wellbore casing that is accessible and/or selected by a user from a pre-existing library of abandonment procedures (e.g., stored on storage device(s) 308 as file(s) 316). The specific milling tools and wellbore casings may also be selected from pre-existing files. For instance, a company may generate and maintain a log, journal, or other record of milling tools and wellbore casings that have been used or designed in the past and any of these, among others, may be stored in the pre-existing library of BHAs. Selecting a milling tool and/or wellbore casing from the pre-existing library may be done by the user using the GUI 312 and/or input device(s) 322, executed by the computing processor(s) 306, and may be visualized or otherwise rendered with the appropriate output device(s) 324.

In the same or other embodiments, the BHA assembles and wellbore casings and other abandonment components to be visualized and/or used in a simulation may be created or customized by the user (e.g., using the GUI 312). The user may create or customize any abandonment component(s), for example, by inputting, selecting, or modifying the abandonment components and/or their parameters with the GUI 312.

Additionally, any simulation of an abandonment procedure may be designed or customized by any combination of accessing, inputting, selecting, or modifying corresponding parameters with the GUI 312. For instance, the computing device 302 may present to the user a number of abandonment components (e.g., milling tool, BHA components, wellbore components, wellbore casings, wellbore abandonment procedures, etc.) for selection. The user may select one or more of the components to be included in a simulation. Based on the selection, a number of corresponding parameters may also be presented to the user via the GUI 312. In some embodiments, the user may instead, or additionally, modify a particular component based on desired or known operating parameters or any other conditions known to a person having ordinary skill in the art in view of the disclosure herein. A simulation may therefore be fully or partially based on any combination of pre-existing data, real-time data, customized data, or the like.

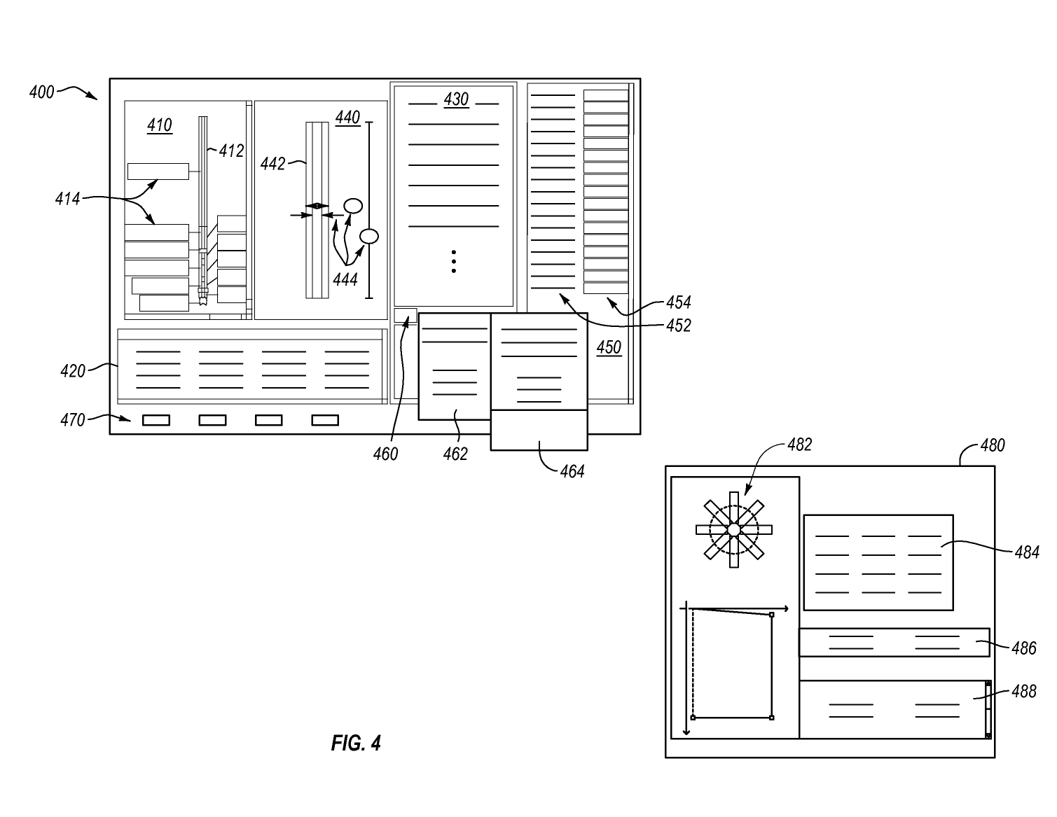

Various embodiments of some of the interfaces that can be provided by the GUI 312 are now described with reference to FIGS. 4-7. Aspects of the GUI 312 are generalized, such that it will be appreciated that the GUI 312 interfaces have elements that may be omitted, repeated, substituted, combined, added, or otherwise modified from what is explicitly shown. Accordingly, embodiments for presenting or utilizing the GUI 312 should not be considered limited to the specific arrangements the GUI 312 elements shown in FIGS. 4-7.

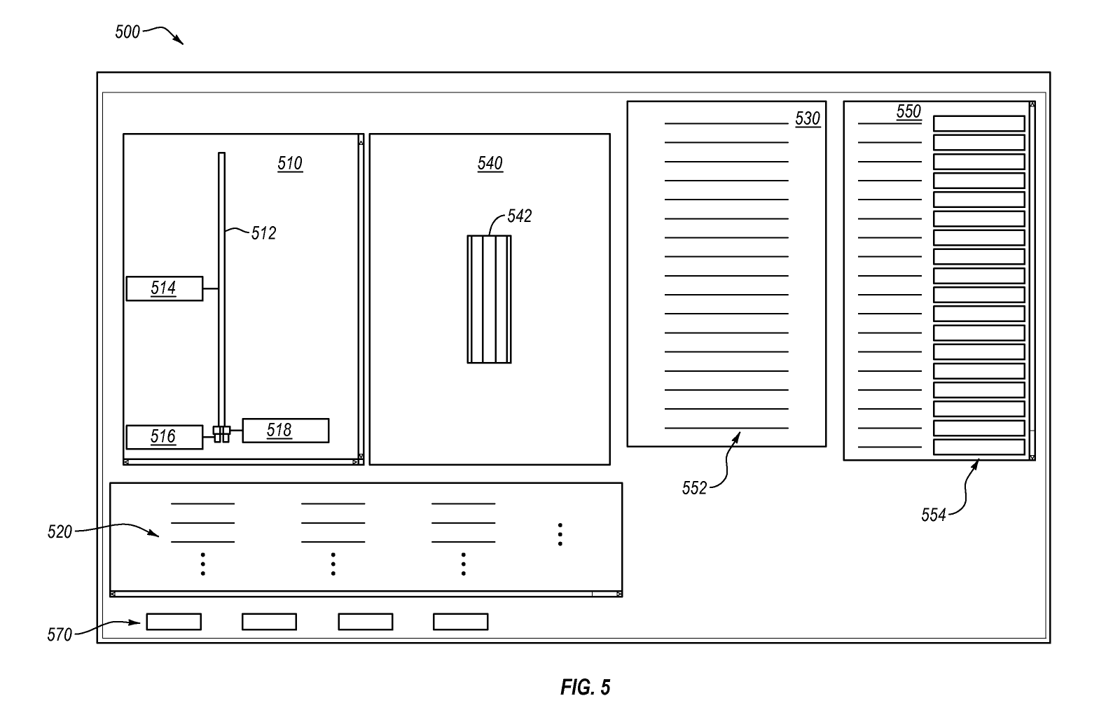

FIGS. 4 and 5 illustrate interfaces of the GUI 312 that include optionally selectable elements that are operable for creating, accessing, selecting, modifying, or otherwise customizing or specifying a milling tool or other abandonment component. These interfaces are usable by an engineer, BHA designer, field technician, or other user to select/input/modify a series of information about milling tools and other BHA components, such as drill strings, bits/mills, hole enlargement tools, cementing strings, isolation devices (e.g., bridge plugs) and other abandonment BHA components.

As shown in FIG. 4, an interface 400 of the GUI 312 (FIG. 3) may include a BHA view 410 showing a BHA 412 that is currently being designed, selected, visualized, or simulated for an abandonment procedure. The BHA 412 is illustrated with optional detailed callouts 414 that identify and provide parameter information for some of the different BHA components that are illustrated (e.g., parameters for a section mill). The particular components illustrated, however, should not be viewed as limiting the scope of this disclosure and can, therefore, include any BHA components, including cutting tools such as drill bits, hole enlargement tools (e.g., hole openers, reamers, etc.), or mills (e.g., window mill, taper mill, dress mill, follow mill, dress mill, watermelon mill, drill-mill, junk mill, rotary steerable mill, section mill, casing mill, etc.), or other tools including drill collars, stabilizers, MWD/LWD tools, downhole motors, jars, drill pipes, transition drill pipes, vibration dampening tools, vibration inducing tools, shock subs, stabilizers, cross-overs, circulation subs, disconnect subs, and so forth. Indeed, in some embodiments, a full length of a drill string and each component of the BHA may be specified and identified in the BHA view 410 and/or illustrated as BHA 412.

In some embodiments, for example, the BHA will include a bi-mill having two cutting tools (e.g., two section mills; a section mill and a follow-mill; a lead mill and a section mill; etc.). In another embodiment, the BHA will include a tri-mill having at least three cutting tools (e.g., two section mills and a reamer; a lead mill, section mill, and reamer; a lead mill and two section mills; etc.). In other embodiments, the BHA will include a spear or other fishing tool. In still other embodiments, the BHA may include any combination of one or more drill bits, stabilizers, plug/isolation tools, other components, or any combination of the foregoing. Each component includes parameters that are selectably modifiable by a user to control the corresponding simulation and visualization of each corresponding component. One or more stabilizers, drill collars, and the like may also be specified as part of the BHA.

The interface 400 also includes a data listing 420 that includes a detailed listing of one or more specific types of a cutting tool component that is identified in the BHA 412 and that is selectable from a component listing 430, which includes a plurality of listed and selectable components (e.g., casing mills, section mills, stabilizers, drill collars, hole enlargement tools, etc.). Parameters of the listed components can also be visualized within the data listing 420.

When a component is selected from the component listing 430, a visualization of the component can be presented in a separate window, like window 440, which is presently visualizing a drill collar 442. Dimensions or other parameters of the visualized component(s) in window 440 can also be called out in one or more references 444. The specific parameters, including dimensions and material properties of the selected component(s) are also displayable in another window frame, such as frame 450.

Frame 450 is presently used to list a plurality of parameters 452 and input fields 454 that are operable to receive user input for entering or modifying any of the parameters 452. When a parameter is modified or entered, the GUI 312 (FIG. 3) modifies the visualization in 440 and/or the parameters listed in the data listing 420.

If a desired component is not presently listed in the component listing 430, it may be possible to access additional components by selecting an object like object 460 to access supplemental category listing 462 or supplemental subcategory component listing 464 (which is accessible by selecting a category from one or more listed categories in category listing 462).

Additional interface objects may also be presented, like objects 470, which are selectable to save or select a displayed/listed component for a subsequent simulation of an abandonment process or for inclusion into a milling tool and/or wellbore casing.

Objects 470 can also be provided for accessing one or more additional interfaces for viewing, modifying, or saving milling tools and other abandonment components. For instance, one of the displayed interactive objects 470 may be selected to cause the display of interface 480, which is presently illustrating aspects of a casing mill tool, along with a visualization window 482 showing visualizations associated with the milling tool. The visualizations in the visualization window 482 may be based on parameters for the corresponding component. In FIG. 4, the visualization window 482 shows multiple views of the casing mill tool, and features such as the number of blades, orientation of the blades, shape of the blades, thickness of the blades, body size, and the like may be visualized. The specified or identified parameters used in producing the visualization in visualization window 482 may be found, for instance, in one or more milling tool parameter windows 484, 486, and 488, which can be used to view, select, enter, modify save, or otherwise interact with one or more corresponding milling tool parameters associated with the visualized milling tool. In some embodiments, the additional interface 480 is accessible through supplemental subcategory component listing 464.

FIG. 5 illustrates a similar interface 500 to the interface 400 of FIG. 4. As shown, the interface 500 includes a BHA view 510 showing a BHA 512 (milling tool) that is currently being designed and visualized and/or simulated. As the BHA 512 is designed, additional components may be selected and added, components may be moved, components may be replaced, or components may be removed. The BHA view 510 may visually show changes to the BHA 512 as different components and parameters are specified.

The BHA 512 is also illustrated with various detailed callouts that identify and provide parameter information for some of the different BHA components. In this embodiment, the first call out 514 may be for a drill pipe, a second callout 516 may be for a taper mill, and a third callout 518 may be for a section mill or reamer. Other combinations of components may also be specified. Each callout can include corresponding identifiers and/or parameters.

An example visualization of a drill pipe 542 for use in a drill string is shown in window 540. Any portion(s) of the abandonment components identified by the interface 500 can be visualized. In some embodiments, the visualization window 540 visualizes a component selected from the visualization in the BHA view window 510. In another embodiment a user is able to select a component for visualization from another frame, such as from a listing in frames 530 or 550.

The user can also select and modify listed parameters 552 with input fields 554 provided in frame 550 or one or more other locations, such as listing 520.

Some objects and listings, and potentially each object and listing, can include a selectable object which, when selected, enables a user to provide additional input to modify a parameter and/or cause the corresponding abandonment component or assembly to be visualized and/or simulated.

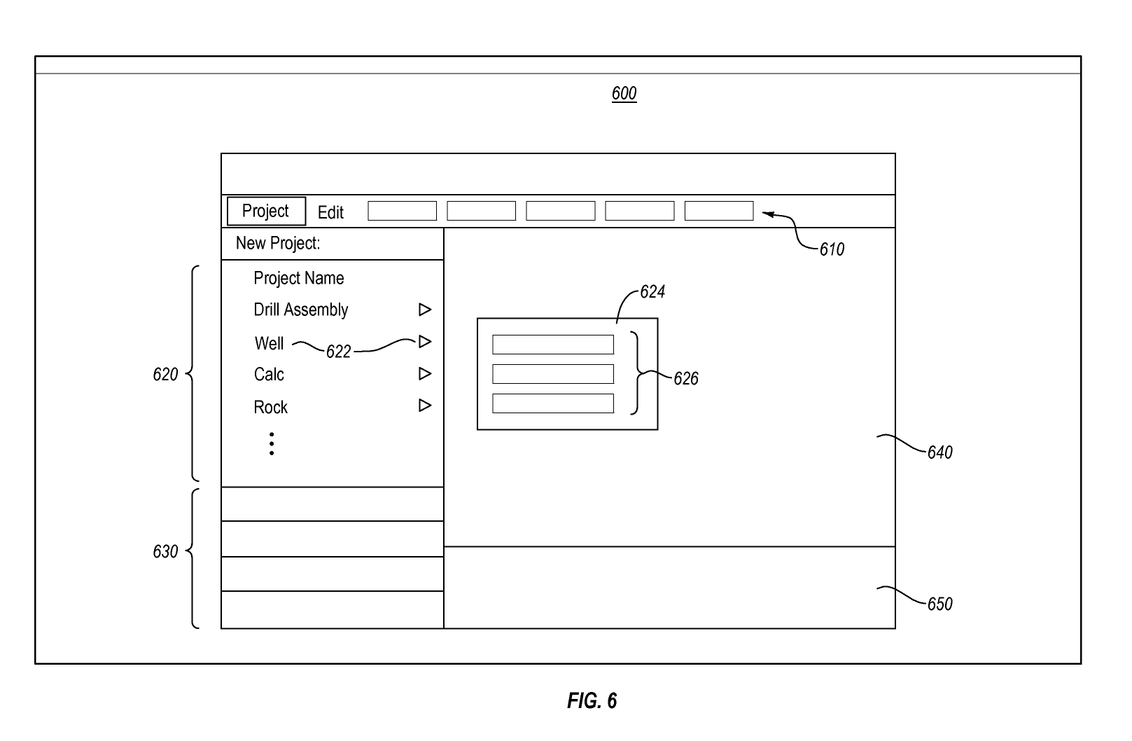

FIG. 6 shows an interface 600 that includes a plurality of selectable menu options 610 for accessing and interfacing with different milling tools, wellbore casings and/or corresponding simulation files. These options include a project option which, when selected, displays a plurality of new selectable options 620 for accessing and interfacing with different portions of a simulation file. For instance, selection of option 622 (either the text link or the object link) causes a display of a new frame 624 that has interactive objects 626 that are operable (when selected) to input, select and/or modify different parameters for a wellbore casing.

Additional interactive elements 630 can also be used, when selected, to open, copy, modify, visualize, initiate, or quit a particular simulation or project.

Visualizations of abandonment components and simulations and simulation results can be rendered in different interface windows 640 and 650, of which one window may visualize an abandonment component and the other window may visualize performance data or parameters associated with the abandonment component.

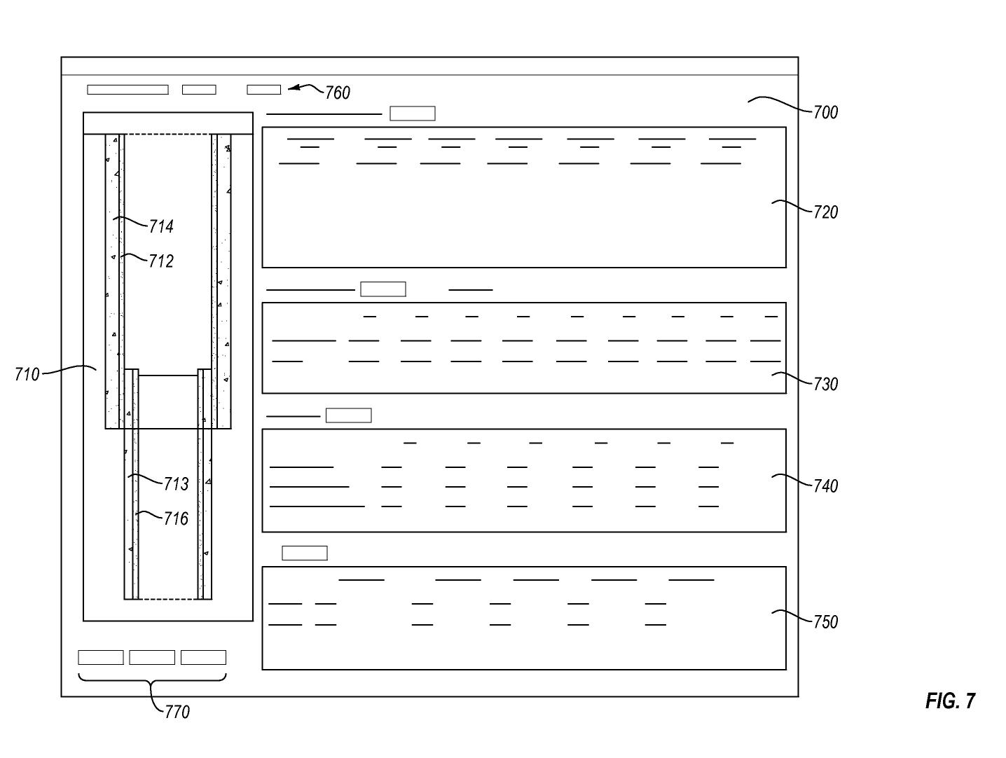

FIG. 7 shows another interface 700 that includes interactive objects that are selectably operable to access and modify different abandonment components. In this embodiment, a first frame 710 is used to display a wellbore casing that includes an outer casing 714 and an inner casing 716 nested within the outer casing 714. Cement layers 713 and 714 that surround the casings (714 and 716) are also visualized.

Different parameter frames 720, 730, 740, and 750 each display different parameters corresponding to the different components that are visualized in the display frame 710. For instance, frame 720 displays parameters for the inner casing 716, frame 740 displays parameters for the outer casing 712, frame 750 displays parameters for the cement layer 713, and frame 760 displays parameters for the cement layer 714. Additional or fewer frames can be displayed in response to user input directed at interactive display objects 760, for different components. The display objects 760 can also be used, when selected, to control which parameters are displayed in any given frame. The parameters in each frame are operable, when selected to be modified in response to user input directed at the parameters.

Interactive objects 770 are also provided which, when selected, enable a user to control the visualization properties (e.g., to select components to be displayed and how they are displayed within the display frame 710).

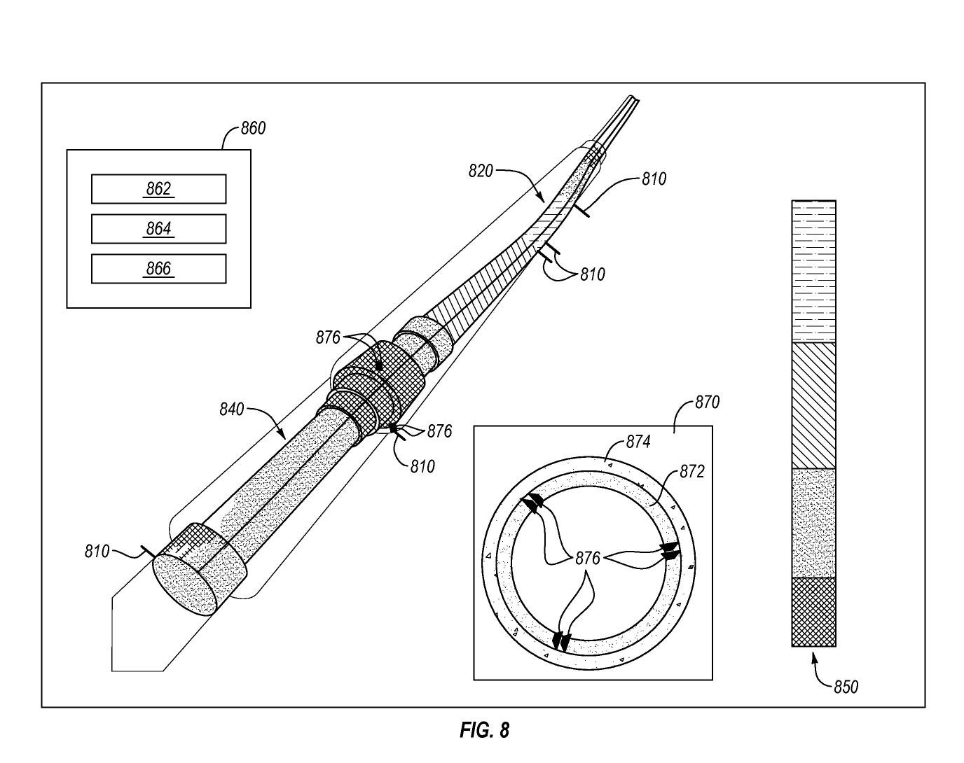

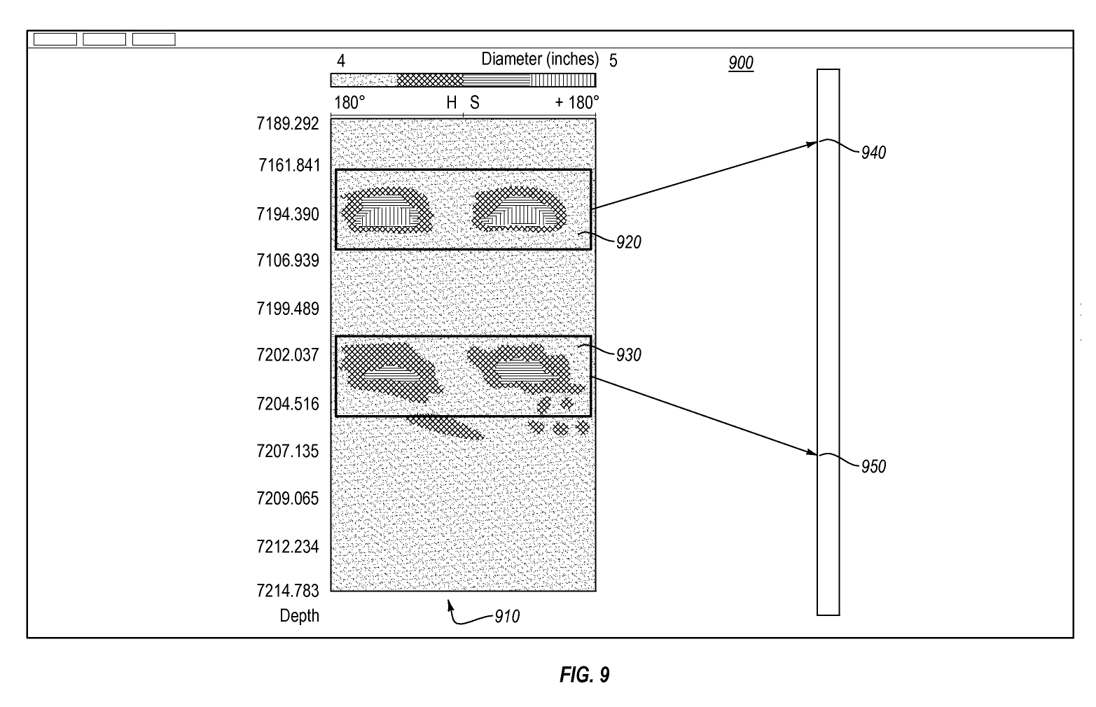

As described herein, after a simulation is performed, the results of the simulation can be visualized or otherwise output in any number of forms. Example formats used to reflect an impact of a simulation are shown, for example, by the illustrations of FIGS. 8 and 9.

FIG. 8 illustrates a visualization of a simulation defined by the parameters selected by a user in one or more of the interfaces provided by the GUI 312. In this simulation, the contact forces and bending moment of a milling BHA 840 are visually illustrated/animated with elements 810 and contour 820, respectively. A color/pattern scheme defined by legend 850 may be applied to the BHA 840 to reflect corresponding forces that are defined by the legend. For instance, each color may be associated with a different force level. As the simulation is performed, the forces at different locations on the BHA 840 can be identified, and the BHA 840 can be color-coded based on the forces at each different location. Using the legend 850, a user may then easily view the conditions at different portions of the BHA 840 at a particular moment in time, or progressively as an animation or other visualization progresses through an abandonment operation.

In some embodiments, a simulation can also include simulation parameters that are displayed and that are selectably modifiable to control the simulation accordingly. For instance, window 860 may include interactive elements 862, 864, and 866 which, when selected and have input received therein, are operable to control the RPM, WOB, load, or other simulation parameters of the BHA 840. When any of these parameters is changed, the GUI 312 (FIG. 3) may modify the simulation and corresponding visual output accordingly, based on an interaction of the milling tool (or other BHA) parameters and the wellbore casing, formation, whipstock, or other parameters that are defined for the particular simulation. This can be useful for enabling a user to instantaneously visualize an impact of a parameter change to a particular abandonment operation, or a particular portion of an abandonment operation.

Returning briefly to FIG. 3, once the user inputs or otherwise customizes one or more abandonment components and other simulation parameters with the GUI 312, the computing device 302 may execute instructions using the computing processor(s) 306 in order to perform a simulation based on the customized abandonment component(s) and the corresponding component parameters selected or input by the user.

The animated simulation includes a simulated interaction between the milling tool (e.g., including mill bits 876) and the wellbore or wellbore casing (e.g., casing 872 and cement 874). Where the simulation includes an interaction of other components (e.g., cementing string, bridge plug, etc.), the animated simulation may include a simulated interaction between such a component and the wellbore or wellbore casing(s).

The simulation may be performed by the simulation engine 312-3 of the GUI 312 using one or more of the methods set forth herein. In one or more embodiments, the BHA may be modeled with beam elements (using finite element analysis (FEA) techniques as known in the art). Briefly, FEA may involve dividing a body under study into a finite number of pieces (subdomains) called elements. Particular assumptions may then be made on the variation of the unknown dependent variable(s) across each element using so-called interpolation or approximation functions. This approximated variation may be quantified in terms of solution values at special element locations called nodes.

Through this discretization process, the FEA method can set up an algebraic system of equations for unknown nodal values which approximate the continuous solution. Element size, shape, and approximating scheme can be varied to suit the problem, and the method can therefore accurately simulate solutions to problems of complex geometry and loading.

Each beam element may have two nodes. For a MWD/LWD tool, for example, the tool may be divided into beam elements, based on the geometry of the tool and sensor locations. The nodes may be located at the division points of the elements. During the simulation, a milling tool may pass radially through one or more casing layers and cement layers. When the milling tool moves (e.g., rotates or moves axially) relative to the wellbore casing, the nodes will have history of accelerations, velocity, displacement, etc. The location of the nodes with reference to the well center or wellbore can be determined.

Representative results that are produced by a simulation may include: accelerations, velocities, trajectories, contact forces and other determined results at the bit, mill, stabilizers, reamers, drills, and other locations. Any or potentially each of these results may be produced in the form of a time history, box and whisker plot, 2D or 3D animation, picture, other representation, or some combination of the foregoing, including the examples illustrated in the figures.

Executing the simulation may generate a set of performance data (e.g., milling performance parameters). In some cases, the set of performance data generated may depend on the data selected or input by the user and/or data stored in one or more files (e.g., rock or material files based on physical tests or cutting elements scraping corresponding materials). User input may include instructions to generate specific performance data, such as, but not limited to, surface torque, WOB, bit RPM, cutter forces, build up rate, dogleg severity, bending moment, von Mises stress, walk rate, contact forces, tool wear rate, other data, or some combination of the foregoing. Additionally, the performance data may include bit/tool geometry, ROP, or hole size, among other things. The set of performance data may be stored in persistent storage (e.g., on storage device(s) 308) in some embodiments.

After and/or during a simulation, the set of performance data may be visualized through the GUI 312 (e.g., on the output device(s) 316). In some embodiments, visual outputs of the GUI 312 may include tabular data of one or more performance parameters. In the same or other embodiments, the outputs may be in the form of graphs and may be represented as ratios, percentages, absolute numbers, or the like. A graphical visualization of one or more of the bit, blades, cutters, BHA components, or other components may be output. In some embodiments, a graphical visualization (e.g., a 2-D, 3-D, or 4-D graph or plot) may include a color scheme. For instance, a color scheme may represent different components, different levels of forces (e.g., vibrations) or stresses, fatigue, wear rates, or the like.

Some specific, non-limiting examples of visualizing performance data are shown in, and described with respect to, FIGS. 9-19.

FIG. 9 illustrates a combination of animation/visualization data and performance data. In FIG. 9, an interface 900 includes a colored/textured visualization of a wellbore casing, presented as a graph 910 in which two different sections 920 and 930 of the graph are identified as corresponding to two different nodes 940 and 950 on the wellbore casing. These identified section of the graph 920 and 930 are identified as having anomalous thicknesses or widths. This interface 900 may reflect sections 920 and 930 may be damaged or milled away during a downhole procedure.

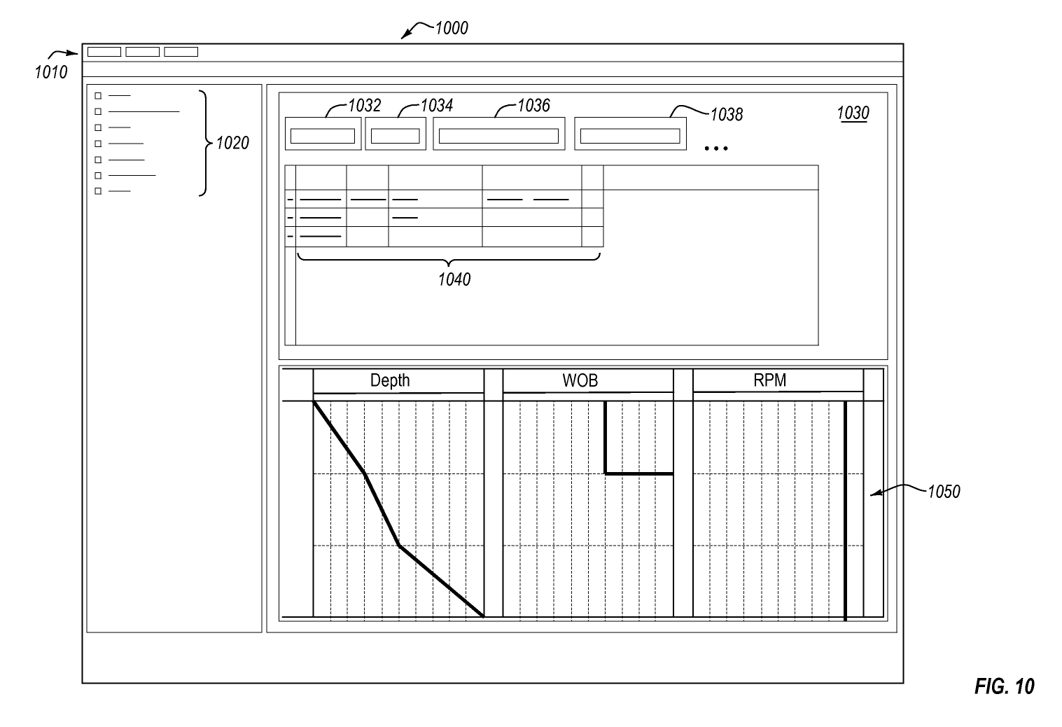

In FIG. 10, an interface 1000 is provided for accessing, selecting, modifying, or otherwise interacting with the parameters of the abandonment components used in a simulation, as well as viewing the performance data of the simulation. For instance, interface 1000 includes various interactive elements 1010, which may be similar to those discussed in reference to the other disclosed interfaces, which are selectable to access and modify parameters. More particularly, in this embodiment, interface 1000 also includes a listing 1020 of various categories of types of abandonment procedures that can be performed. These selectable options, when selected, may cause the interface 1000 to display corresponding abandonment components or simulation parameters of an anticipated abandonment procedure. For instance, a selection of a category type (e.g., bridge plug installation) from listing 1020 can cause interface 1000 to display interactive elements in window 1030 (e.g., different bridge plugs and installation tools).

Window 1030 includes interactive elements which are operable, in response to user input entered therein, to select or modify parameters of abandonment components and corresponding simulation parameters. Example parameters that may be selected and/or modified in window 1030 include milling depth (1032), WOB (1034), RPM (1036), starting depth (1038), casing geometry and/or trajectory, fluid types and levels, and so forth. More detailed parameters for different abandonment phases can be broken out and defined with other interactive elements 1040, as well, by selecting and/or entering information into the corresponding parameter input fields for each phase. Visualizations of the simulation parameters can be presented to the user in one or more additional windows, such as window 1050.

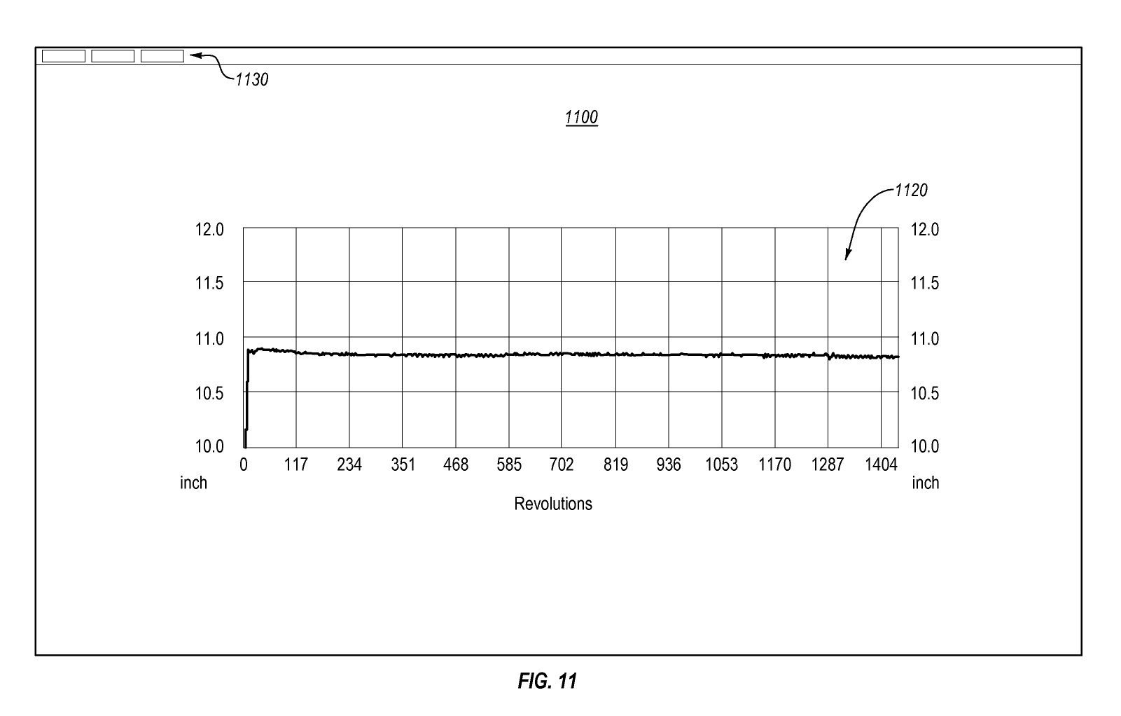

FIG. 11 includes an interface 1100 that includes a graphic plot 1120 of a hole size opened in a wellbore casing by a casing mill. Corresponding plots can also be rendered to reflect a diameter of an area that has been milled by a section mill. While the plot is defined by width per revolution, it would also be possible to render a plot of diameter or width per depth when the simulation involves a section mill, for instance. Options for controlling the displayed content and format are controlled through the selectable options 1130 presented by the interface.

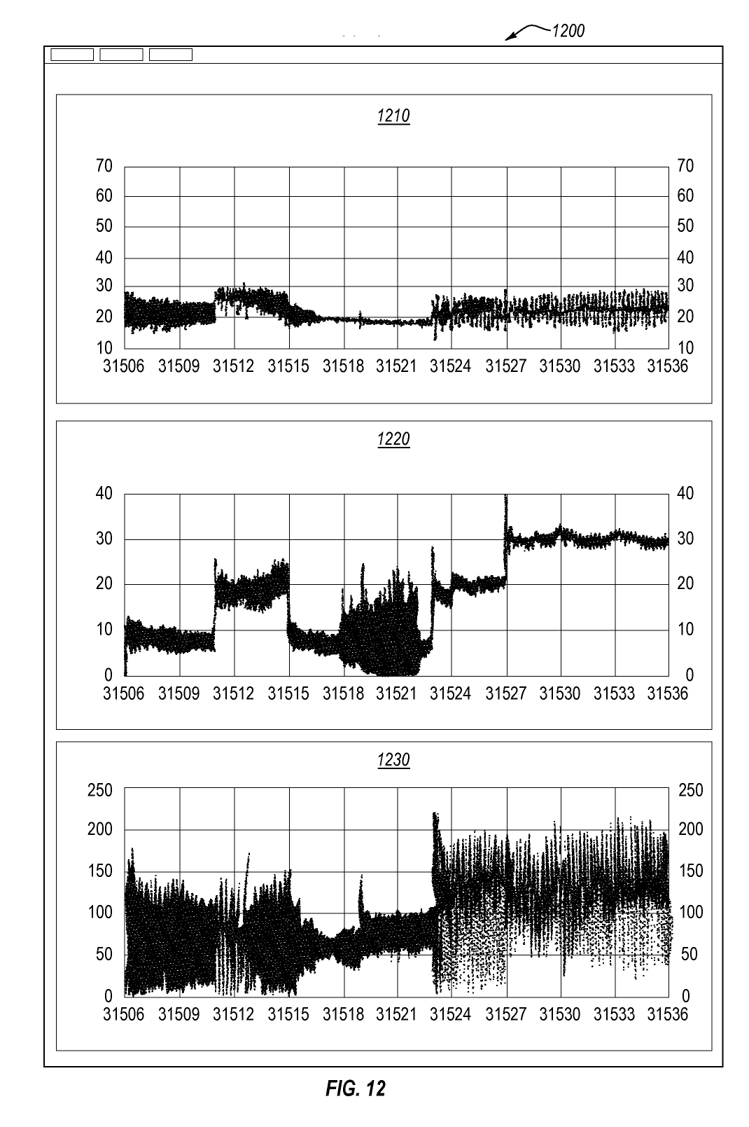

FIG. 12, on the other hand includes an interface 1200 that illustrates performance data (e.g., performance parameters) for a BHA in 2D graphs, including a surface torque graph 1210, a surface WOB graph 1220, and a bit RPM graph 1230, corresponding to a set of defined abandonment component parameters. More particularly, the surface torque graph 1210 is shown as illustrating the surface torque (e.g., in klbf-ft) for different bit depths (e.g., measured in feet). As shown in this particular embodiment, for instance, the surface torque over the illustrated tool depth range may vary from 4 klbf-ft at a tool depth of 31,523 ft. (9,608 m) to a maximum surface torque of 31 klbf-ft at a tool depth of 31,513 ft. (9,605 m).

For the surface WOB graph 1220, the surface WOB (e.g., in klbf) may be shown for different tool depths (e.g., measured in feet). In this embodiment, the surface WOB may vary from a minimum of 0 klbf at a tool depth of 31,520 ft. (9,607 m) to a maximum surface WOB of 40 klbf at a tool depth of 31,527 ft. (9,609 m) from the surface. The bit RPM graph 1230 may similarly show the RPM (e.g., in rotations per minute) of the tool at different tool depths. As shown in this plot, the bit RPM may rapidly fluctuate (e.g., at tool depths between 31,524 ft. (9,609 m) and 31,536 ft. (9,612 m). More particularly, in this plot, the tool is shown as having an RPM which may vary from 0 RPM at a tool depth of 31,512 ft. (9,605 m) to 220 RPM at a tool depth of 31,523 ft. (9,608 m).

The performance data in FIG. 12 is directed to a single BHA, and includes a single set of graphs for different performance parameters of that BHA during a single simulation. In other embodiments, however, the visualized performance data may be varied. For instance, one or more comparative set(s) of graphs can be provided for one or more differently configured BHA(s) performing the same abandonment operation, for the same BHA performing different abandonment operations, or for different BHAs performing different abandonment operations. Further, in some embodiments, different performance data may be provided in a graphical, tabular, or other manner. By way of illustration, downhole torque or vibration data (e.g., lateral, vibrational, or torsional vibrations) may be shown. The different display options are controlled through the interactive elements presented in the interface 1200.

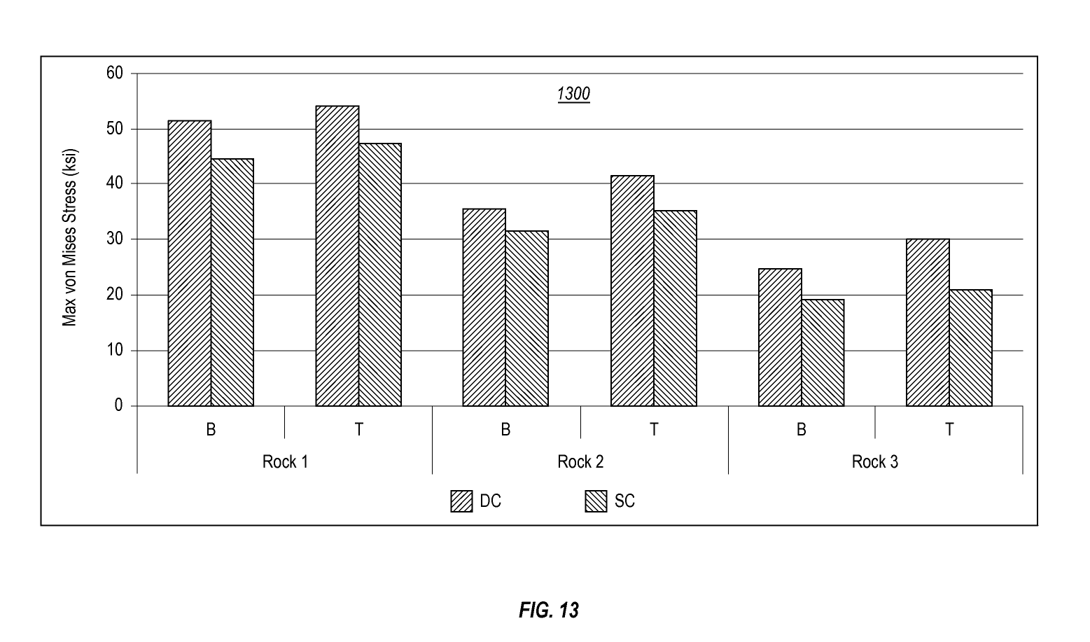

FIG. 13 illustrates yet another form of simulation output and performance data that may be presented as output in the form of a graph 1300. In this graph 1300, a summary of maximum von Mises stresses for two different BHAs (B and T), and several rock types (Rock 1, Rock 2, and Rock 3) are shown. The data may correspond to an abandonment milling operation. In some embodiments, the B BHA may be a bi-mill BHA, and the T BHA may be a tri-mill BHA. Results of single casing (SC) and dual casing (DC) milling scenarios are also represented. In this particular embodiment, Rock 1 had a rock strength of 2-5 ksi, Rock 2 had a rock strength of 5-10 ksi, and Rock 3 had a rock strength of 20-30 ksi. As shown, stress on a tri-mill may generally be expected to be higher than on a bi-mill. Similarly, higher stresses are generally expected for dual casing milling procedures relative to single casing milling procedures. In this embodiment, for higher rock strength, lower stress may be expected. In other embodiments, different results may be obtained (e.g., for differently arranged BHAs, for BHAs where cutting tools are actuated at different times, for different depths of cut, etc.).

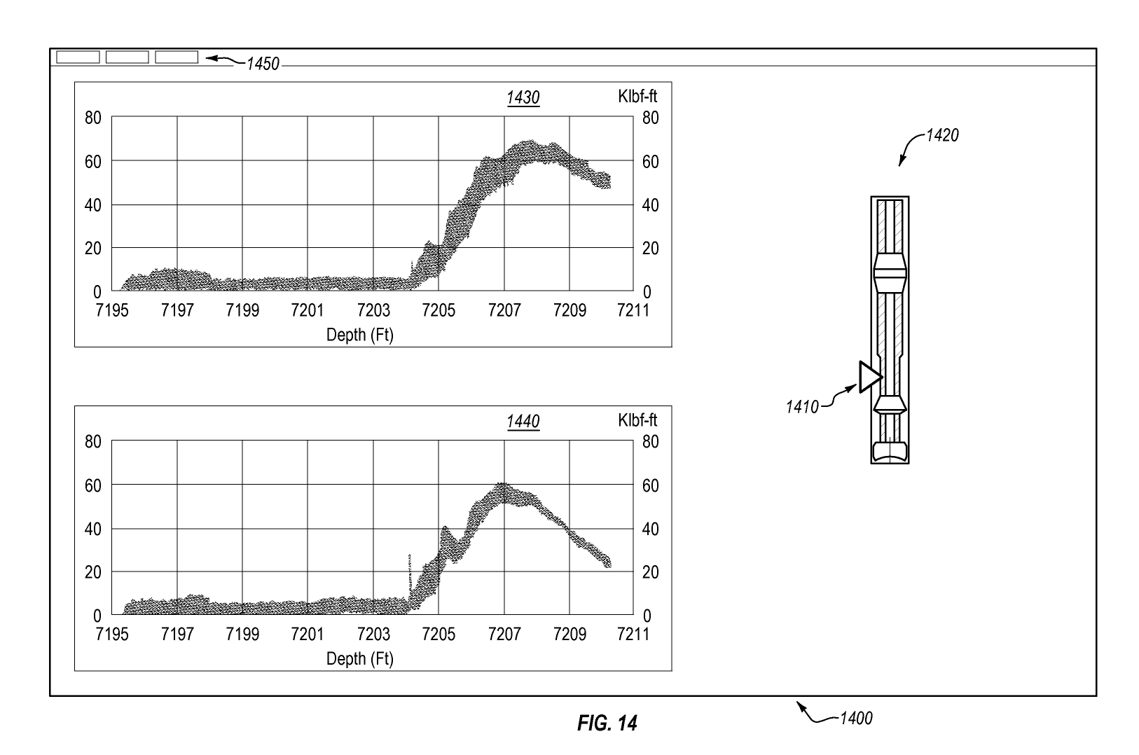

FIG. 14 illustrates another embodiment of an interface 1400 for controllably displaying simulation output. In this embodiment, the simulation output includes performance data that reflects internal forces for a particular node 1410 of a virtual BHA 1420 (e.g., a tri-mill BHA) that was selected, designed, modified, or otherwise defined according to the techniques described herein (e.g., with any of the interfaces described herein or other interfaces that are provided by the GUI 312). The performance data is displayed in two historical plots. The first historical plot 1430 shows internal stresses occurring at the node 1410 during a simulation of an abandonment process in which the virtual BHA 1420 operates in a downhole casing environment that includes a virtual dual casing wellbore. Historical plot 1430, on the other hand, reflects the internal stresses occurring at the node 1410 when performing a similar simulation of an abandonment procedure of the virtual BHA 1420 and a downhole environment that includes a single casing wellbore.

In some embodiments, the user can selectably interact with the node object 1410, by selecting and moving the node object to another node to thereby cause the computing system to render different output corresponding to the other node. In the same or other embodiments, the user can select a plurality of different nodes on the virtual BHA to cause the computing system to dynamically generate/render a plurality of corresponding outputs for the selected nodes.

The user can also utilize the interface objects to select different types of simulation outputs to render, as well as different simulation scenarios to graph, in the simulation output. When the interface objects 1450 are selected, the interface 1400 displays different selectable options for modifying the simulation scenarios, graphing options (e.g., types of graphs, performance metrics to graph, etc.), node selection options, BHA component selection options, and so forth.

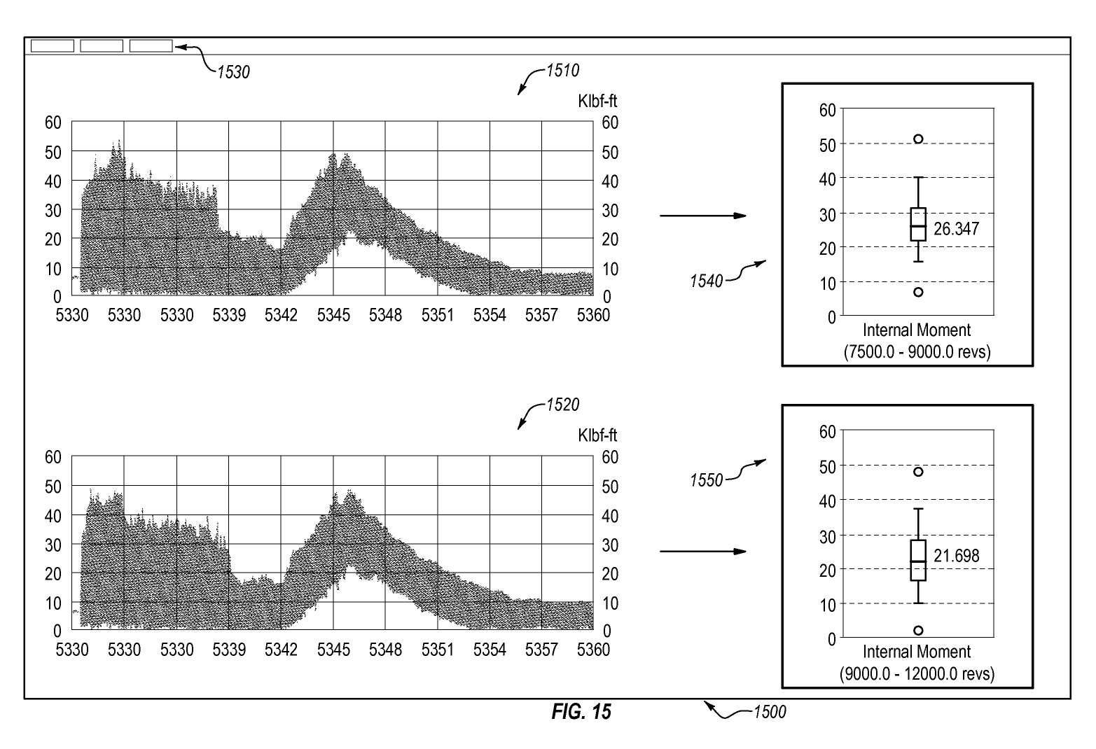

FIG. 15 illustrates yet another embodiment of an interface 1500 for controllably displaying simulation output. In this embodiment, historical plots 1510 and 1520 of internal forces are graphed for a particular node of a virtual abandonment component that were calculated to occur during simulated abandonment procedures involving cemented casing(s) (plot 1510) and non-cemented casing(s) (plot 1520). While the corresponding BHA components and selected node are not currently displayed in the interface 1500, they can be selectably displayed and/or modified by selecting interactive objects 1530, as described herein.

The interactive objects 1530 can also be used to select the display of additional images and graphs, such as the uncertainty plots 1540 and 1550, which visually indicate that cement behind a casing could, in this embodiment, reduce the corresponding bending moment by up to 20% or more.

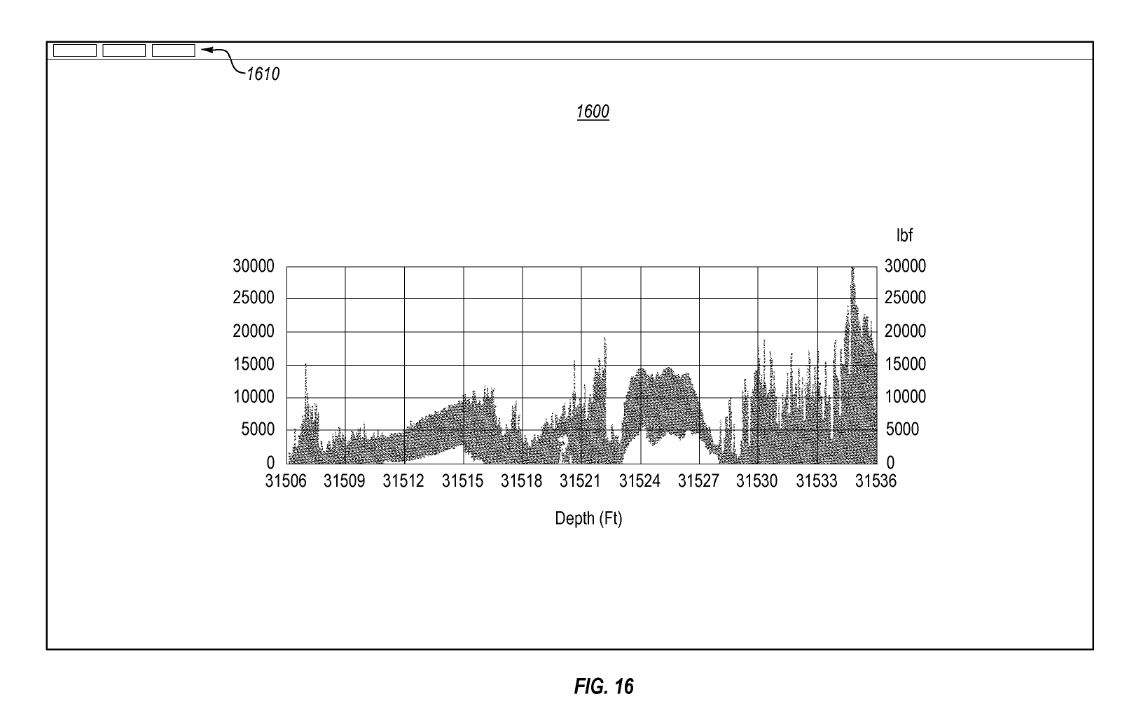

In the embodiment of FIG. 16, the interactive objects 1610 of the interface 1600 are used to select a single graph of performance data including a historical plot of contact forces at a selected node (node X), per drill depth, during a particular simulated abandonment procedure. As discussed herein, the node and abandonment component parameters, as well as the graphing options, are selectably controllable through menu options or other provided in response to selecting the interactive objects 1610.

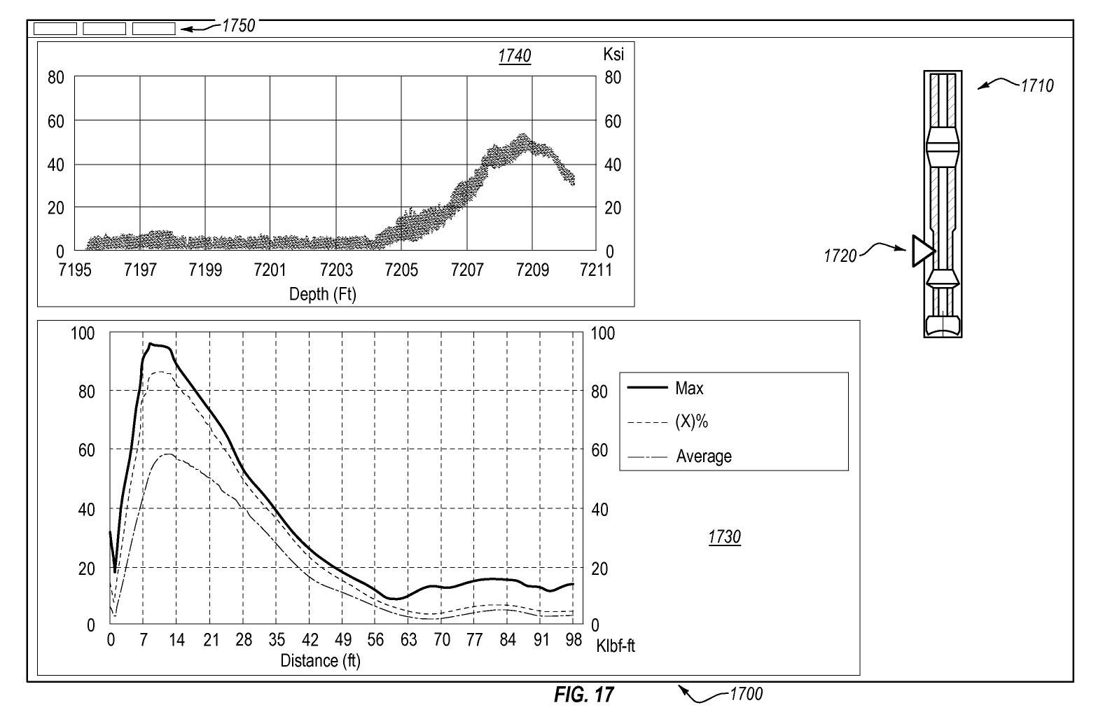

FIG. 17 illustrates another example of how performance data can be rendered by the interfaces of the GUI 312 for simulated abandonment procedures. In this embodiment, an interface 1700 displays a virtual BHA 1710 and a node selection object 1720, which is positioned at a user-specified location on the virtual BHA 1710. The interface 1700 also includes a first graph 1730 of bending moments for the virtual BHA assembly 1710 (which may include any combination of milling, plugging, hole enlargement, stabilizing, or other components) relative to a distance of a variable node from a lead cutting tool on the virtual BHA 1710. The graphed bending moments include max bending moments, average bending moments and bending moments that are a selected percentage of the bending moments occurring at the variable distances. The various output parameters are all selectable through the interactive objects 1750 of the interface 1700, as generally described herein with regard to the other interface embodiments.

The bending moments are also plotted as a function of downhole depth in another plot 1740. This plot 1740 specifically shows bending moments occurring over time for a selected simulation at a particular node defined by node selection object 1720. Any of the plot parameters used to control the rendering of the performance data for plots 1730 and 1740 can be modified through selectable options that are presented to a user in response to a user selection of the interactive objects 1750.

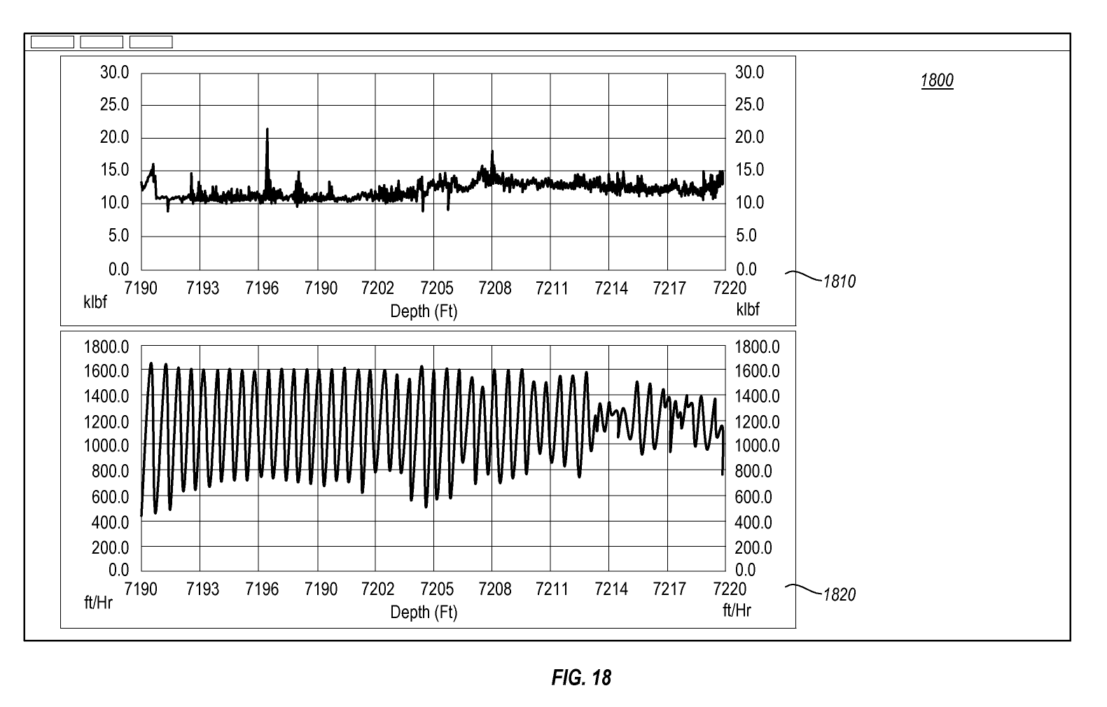

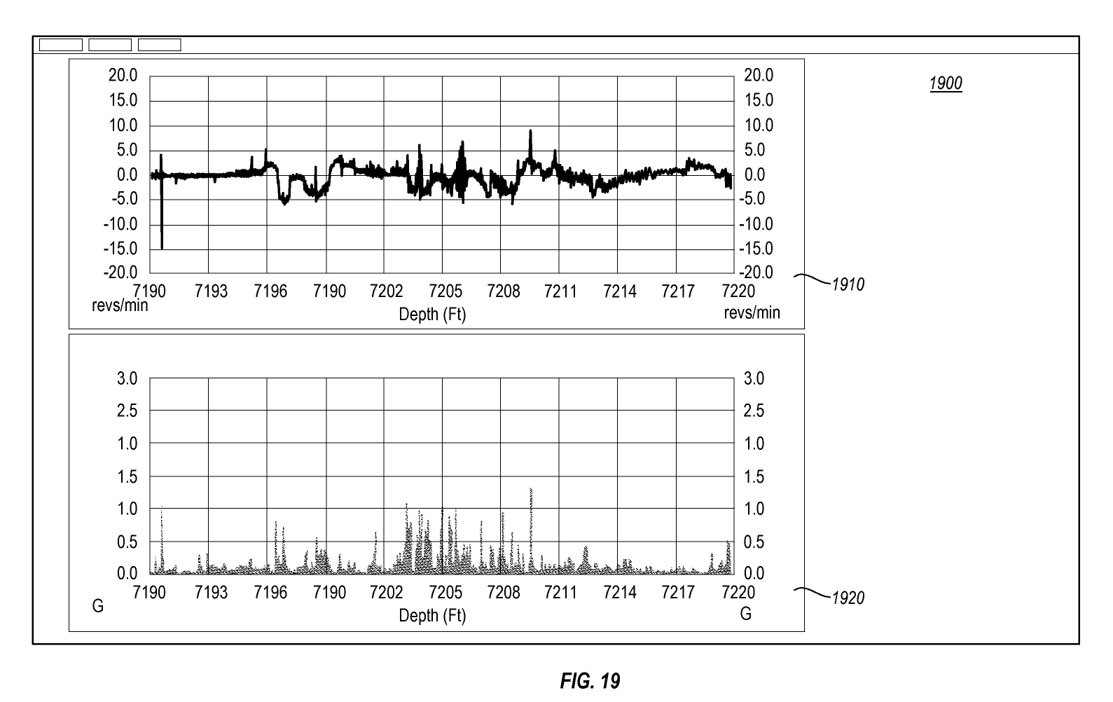

In another set of interfaces 1800 and 1900, shown in FIGS. 18 and 19, various additional graphs may be presented, with each showing performance data for a particular node based on depth or distance from surface. The first graph 1810 shows a surface weight on bit (SWOB) at particular depths of a downhole environment for a particular simulated abandonment procedure with one or more abandonment components. The next graph 1820 shows corresponding rate of penetration performance data for a same or different simulated abandonment procedure (e.g., rate at which casing is milled). Graph 1910 shows corresponding bit revolution per minute (RPM) performance data for a same or different simulated abandonment procedure. Graph 1920 shows corresponding axial acceleration penetration performance data for a same or different simulated abandonment procedure.

Any combination of performance data graphs can be selected for display, as can the graphing options, in response to a user selection of an interactive menu object displayed by the interface 1800 and 1900. For instance, a user can select an interactive menu object displayed by the interface 1900 to cause the interface 1900 to display additional graphing options which enable the user to select additional or other graphs to be displayed (e.g., lateral acceleration, or any other graphing option) corresponding to a simulated abandonment procedure.

In some embodiments, once a simulation is run and after the user is presented with a set of performance data and/or the simulation visualizations, the user may modify at least one parameter associated with the simulation (e.g., any abandonment component or corresponding simulation parameter), such as, for example, a quantity, position, location, or size of nested casings, dimensions of removed casing section, cutting tool parameters, cutting tool RPM, axial acceleration, milling tool size or location, rotational speed, weight-on-bit, and so forth. Modification may involve selecting a parameter from pre-existing values or receiving input of the parameter with any of the interfaces of the GUI 312 (FIG. 3) to obtain a modified BHA, a modified wellbore or wellbore casing environment, a modified abandonment procedure, or some combination of the foregoing.

After modification, a second simulation may optionally be executed (e.g., by the computing system 300 of FIG. 3). The second simulation may include use of the modified simulation parameter(s) and may generate a second set of performance data.

Similar to the first simulation, the second simulation may include instructions to generate specific performance data, such as, but not limited to, surface torque, weight on bit (WOB), surface weight on bit (SWOB), bit RPM, cutter forces, build-up rate, bending moment, von Mises stress, window quality, window size/geometry, resulting whip profile, walk rate, contact forces, vibrational data, axial acceleration, lateral acceleration, other data, or some combination of the foregoing. Additionally, the performance data may include resulting bit/tool geometry (e.g., after wear of cutting elements), wear rate, rate of penetration (ROP), surface weight on bit, hole size/geometry, or hole quality, among others. The set of performance data may be stored (e.g., persistently on storage device(s) 308).

The initial set of performance data and the second set of performance data may be presented using GUI 312 (FIG. 3) and an output device(s) 316 (FIG. 3). The sets of performance data may be presented to the user for comparison and may be presented separately or in combination. The sets of performance data may be presented or visualized using any tools known to a person having ordinary skill in the art in view of the disclosure herein, such as, for example, plots, graphs, charts, and logs. In some embodiments, differences between the sets of performance data may be presented in lieu of the sets of performance data themselves.

Further, similar to the first and second simulation requests, field data may be obtained from one or more sensors (e.g., an MWD or LWD, a downhole sensor, a surface sensor, etc.) to generate additional sets of performance data to compare to the first and/or second sets of performance data. Any of the foregoing performance data can then be used to selectably tune/calibrate the simulation system. With a calibrated simulation system, additional or other simulations may be run to otherwise improve a design of a BHA, a corresponding milling tool, or abandonment procedure. In some embodiments, sensors used to obtain field data may be located at one or more discrete locations on a BHA. In some embodiments, the obtained field data may be used to tune/calibrate a simulation system by comparing field data to simulated results for the corresponding, discrete locations on the BHA. The calibration may also increase reliability of simulated performance data at other locations within the BHA, and for which field data is not available.

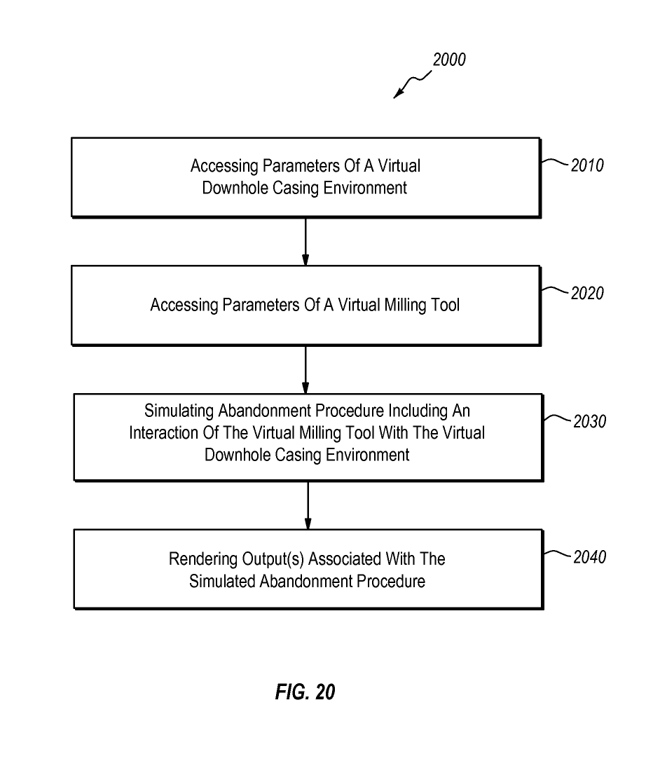

The abandonment simulations described herein may be performed using one or more of the methods set forth below or as otherwise described herein. By way of example, FIGS. 20-22 illustrate flow diagrams of some of the methods that can be implemented for simulating abandonment procedures.

The flow diagram 2000, shown in FIG. 20, illustrates one method that can be implemented by a computing system (like system 300 of FIG. 3), for simulating an abandonment procedure. This method includes the computing system accessing parameters of a virtual downhole casing environment (act 2010) and parameters of a virtual milling tool (act 2020). This is accomplished with the interfaces provided by GUI 312, as described above. The computing system also uses the interfaces to simulate an abandonment procedure by at least simulating an interaction of the virtual milling tool with the virtual downhole casing environment (act 2030). Corresponding output associated with the simulated abandonment procedure may then be rendered in one or more different formats by the interfaces of the GUI 312 (act 2040).

As indicated above, the virtual milling tool may include section mills or casing mills that are capable of milling an axially and removing a full or partial thickness of casing lining a wellbore wall, or any other mills or drills that are capable of removing debris and other material from a wellbore (e.g., cement, earth formation, tools, sensors, whipstocks, casing, etc.). The virtual downhole casing environment, on the other hand, may include any material located in or adjacent to the sections of the casing being removed during an abandonment procedure (e.g., one or more additional casing(s), cement layer(s), earth formation(s), tool(s), sensor(s), whipstock(s), fluid(s), plug(s), etc.).

In some embodiments, the computing system accesses parameters for the various abandonment components from mesh simulation data defining at least a virtual state of one or more wellbores and/or milling tools following a previous simulation of a downhole procedure involving the one or more wellbores and/or milling tools. In other embodiments, the parameters are obtained from one or more files corresponding to actual field data extracted from one or more sensors or measuring devices.

The computing system 300 (FIG. 3) may utilize the interface engine 312-1 to generate an abandonment simulation interface 312-4 that displays the interactive elements that, in response to user input directed at the interactive elements, select, define, or modify one or more of the milling tool parameters, wellbore casing parameters, or corresponding abandonment components to use in a simulation or visualization. The computing system 300 may also utilize the visualizing engine 312-2 to generate a visual representation of the one or more virtual milling tools or the one or more virtual wellbore casings associated with the user input, and the simulation engine 312-3 may be used to perform a simulation of an abandonment procedure, as described herein.

The computing system may also utilize one or more simulation interfaces 312-4 to render one or more outputs associated with the simulation of the abandonment procedure, including simulation animations, visualizations, and presentations of corresponding performance data, as described herein.

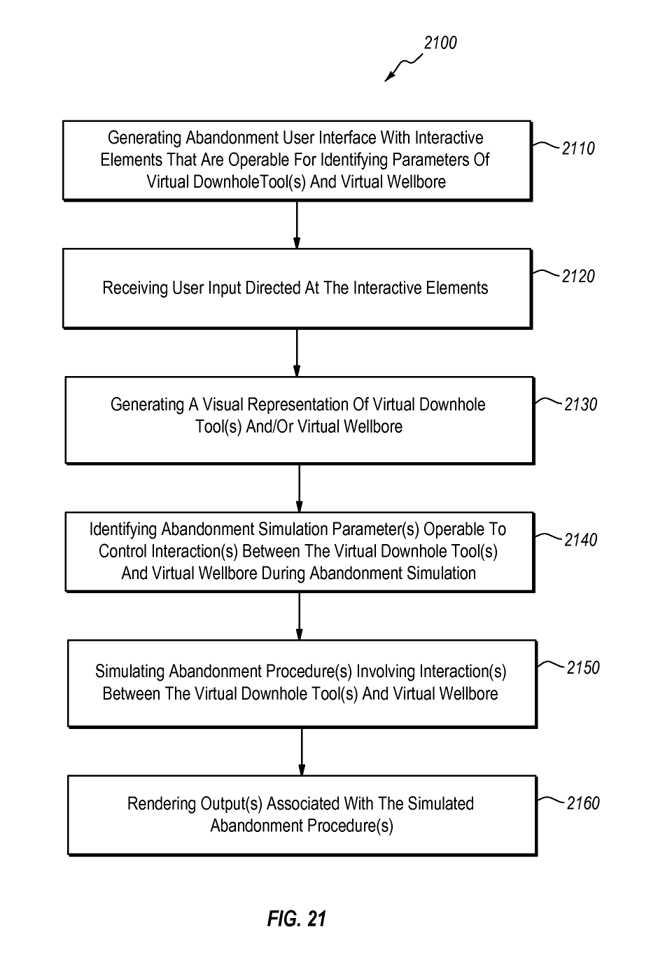

In the flowchart 2100 of FIG. 21, a related method includes a computing system generating an abandonment user interface, like simulation interface 312-4 (act 2110). The abandonment user interface may be operable to identify parameters of virtual downhole tools (e.g., virtual downhole milling, plugging, and other tools) and/or parameters of a virtual wellbore (e.g., direction, size, number and position of casings, type of casings, etc.). Input received at the interactive elements of the interface (act 2120) is used to generate a visual representation of one or more virtual downhole tools and/or virtual wellbores (act 2130). Then, the interface is used (in response to user input directed at the interactive elements) to identify abandonment simulation parameters that are operable to control the interactions between the virtual downhole tools and the virtual wellbore during a simulated abandonment procedure (act 2140). In some instances, the input may select abandonment components and/or corresponding parameters from files that store data from actual field data. In other instances, the input selects (e.g., identifies, defines, or modifies) the abandonment components and corresponding parameters based on virtual data that was not extracted from field data.

The method of FIG. 21 also includes simulating one or more abandonment procedures that involve interactions between at least the virtual downhole tools and the virtual wellbore (act 2150). Simulating the abandonment procedure may correspond to user input received at the interfaces provided by the GUI 312 of the computing system 300, as described herein. The corresponding output(s) from the simulation may then be rendered (act 2160) in one or more different formats, as also described herein.

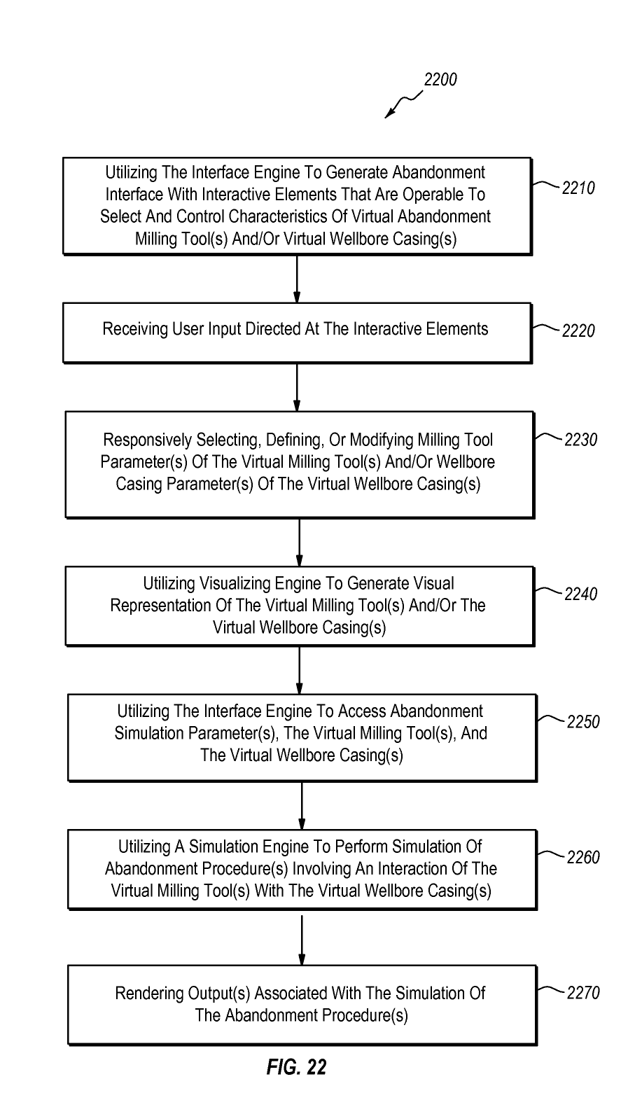

In another method, illustrated by the flowchart 2200 of FIG. 22, a computing system (e.g., computing system 300 of FIG. 3) utilizes an interface engine (e.g., interface engine 312-1) to generate an abandonment interface (e.g., abandonment interface 312-4) and interactive elements (act 2210), which are used to receive the user input (act 2220) for selecting, defining, or modifying the parameters of the virtual abandonment milling tools and virtual wellbore casings (act 2230).

The computing system utilizes a visualizing engine to generate a visual representation(s) of selected abandonment components (e.g., the virtual milling tool(s) and/or the virtual wellbore casing(s)) (act 2240). The computing system 300 also uses the interface engine to access simulation parameters and the corresponding virtual milling tool(s) and wellbore casing(s) to be used in a simulation of an abandonment procedure (act 2250). Then, a simulation engine is used to perform a simulation of an abandonment procedure that involves at least an interaction of the virtual milling tool(s) and wellbore casing(s) (act 2260). Output is then rendered by the computing system 300 to reflect attributes and characteristics of the abandonment procedure (act 2270).

Although many of the foregoing embodiments are specifically described in reference to abandonment procedures in which material is extracted from a wellbore, it will be appreciated that the systems, interfaces and methods of the present disclosure can also be used to perform abandonment procedures that include adding material to a wellbore. For instance, in one embodiment the abandonment procedure is the positioning/adding of a plug to a wellbore, such that a virtual plug is used instead of, or in addition to, a virtual milling tool in the processes described herein. In such an embodiment, the abandonment procedure that is simulated may include a simulated installation of a plug (e.g., a cement plug, a bridge plug, etc.) in a wellbore region where at least a portion of the one or more virtual wellbore casings were previously removed by a selected one or more virtual milling tools, or in which the casing environment was designed with a void region where the virtual plug is installed. In some embodiments, an abandonment procedure may be simulated that includes installing a plug or other isolation tool within casing. For instance, a bridge plug may be installed in casing to isolate a portion of the wellbore and form a base for a cement plug to be installed. The cement plug may then be formed in the cased and/or section milled portion of the wellbore.

In some instances, a virtual BHA (including the virtual milling tool(s) used in the simulation of an abandonment procedure) replicate an actual BHA that was previously used to perform a correspondingly similar and actual abandonment procedure. In the same or other embodiments, the virtual BHA is designed from scratch or by modifying a stored file of a virtual BHA that does not replicate an actual BHA that was previously used in an actual abandonment procedure.

The virtual BHA may then be modified into a virtual modified BHA, in response to user input, to change one or more components of the BHA or one or more corresponding parameters of the BHA components. The virtual modified BHA may then be used in another simulation of the abandonment procedure to determine which of the virtual BHAs is better suited for the abandonment procedure and whether the virtual modifications should also be made in real life for an actual corresponding abandonment procedure, thereby enabling a user to more efficiently predict performance of an abandonment component for an abandonment procedure and/or to compare and contrast performance characteristics of one or more abandonment components for various downhole casing environments.

In some embodiments, a BHA designer may also review simulated performance of a BHA as a function of location along the BHA (or distance from a cutting tool or other component). By providing outputs that show performance as a function of length or distance, the BHA designer can obtain information indicative of locations with high stress, high vibration, high accelerations, or other deleterious effects. The BHA designer can then add, remove, move, or modify components on the BHA to reduce, modify, or eliminate these deleterious effects. By allowing a designer to review locational information, the overall performance of the BHA may be improved.

Aspects of the present disclosure allow a BHA designer to investigate the performance of multiple BHAs having a dynamic input. A dynamic input includes an input that varies during the course of a simulation. For example, the RPM may be varied (e.g., with the bit either drilling or not drilling) to determine a speed to be avoided during drilling. Similarly, the WOB may be varied over the course of the simulation (e.g., from 0 to a selected value, or between two values higher than 0). Similarly, the WOB of the BHA may be entered as a dynamic input, and allowed to change over the course of the simulation. Further still, the size of a bit, stabilizer, mill, hole enlargement tool, or other component may change over time (e.g., as wear occurs). By having a dynamic input (which may be fed into the simulation system from a performance parameter in some embodiments), selected embodiments of the present disclosure may allow a BHA designer to suggest operating parameters to be avoided, or to be used by a driller when actually drilling a well with a correspondingly structured BHA.

Embodiments of the present disclosure may allow for an engineer, or BHA designer, to efficiently select or modify a BHA to be used for abandonment procedures based on corresponding simulation results, models, and performance data. Accordingly, the interfaces and systems of the present disclosure may enable a designer to select the optimized BHA for specific wellbore conditions and/or abandonment procedures. Then, once selected, the optimized BHA is then used for the particular abandonment procedure.

Embodiments of the present disclosure may generally be performed by a computing device or system, and more particularly performed in response to instructions provided by one or more applications or modules executing on one or more computing devices within a system. In other embodiments of the present disclosure, hardware, firmware, software, computer program products, other programming instructions, or any combination of the foregoing, may be used in directing the operation of a computing device or system.

Embodiments of the present disclosure may thus utilize a special purpose or general-purpose computing system including computer hardware, such as, for example, one or more processors and system memory. Embodiments within the scope of the present disclosure also include physical and other computer-readable media for carrying or storing computer-executable instructions and/or data structures, including applications, tables, data, libraries, or other modules used to execute particular functions or direct selection or execution of other modules. Such computer-readable media can be any available media that can be accessed by a general purpose or special purpose computer system. Computer-readable media that store computer-executable instructions (or software instructions) are physical storage media. Computer-readable media that carry computer-executable instructions are transmission media. Thus, by way of example, and not limitation, embodiments of the present disclosure can include at least two distinctly different kinds of computer-readable media, namely physical storage media and/or transmission media. Combinations of physical storage media and transmission media should also be included within the scope of computer-readable media.

Both physical storage media and transmission media may be used temporarily store or carry, software instructions in the form of computer readable program code that allows performance of embodiments of the present disclosure. Physical storage media may further be used to persistently or permanently store such software instructions. Examples of physical storage media include physical memory (e.g., RAM, ROM, EPROM, EEPROM, etc.), optical disk storage (e.g., CD, DVD, HDDVD, Blu-ray, etc.), storage devices (e.g., magnetic disk storage, tape storage, diskette, etc.), flash or other solid-state storage or memory, or any other non-transmission medium which can be used to store program code in the form of computer-executable instructions or data structures and which can be accessed by a general purpose or special purpose computer, whether such program code is stored as or in software, hardware, firmware, or combinations thereof.

A “communication network” may generally be defined as one or more data links that enable the transport of electronic data between computer systems and/or modules, engines, and/or other electronic devices. When information is transferred or provided over a communication network or another communications connection (either hardwired, wireless, or a combination of hardwired or wireless) to a computing device, the computing device properly views the connection as a transmission medium. Transmission media can include a communication network and/or data links, carrier waves, wireless signals, and the like, which can be used to carry desired program or template code means or instructions in the form of computer-executable instructions or data structures and which can be accessed by a general purpose or special purpose computer.

Further, upon reaching various computer system components, program code in the form of computer-executable instructions or data structures can be transferred automatically or manually from transmission media to physical storage media (or vice versa). For example, computer-executable instructions or data structures received over a network or data link can be buffered in memory (e.g., RAM) within a network interface module (NIC), and then eventually transferred to computer system RAM and/or to less volatile physical storage media at a computer system. Thus, it should be understood that physical storage media can be included in computer system components that also (or even primarily) utilize transmission media.

Computer-executable instructions comprise, for example, instructions and data which, when executed at one or more processors, cause a general purpose computer, special purpose computer, or special purpose processing device to perform a certain function or group of functions. The computer-executable instructions may be, for example, binaries, intermediate format instructions such as assembly language, or even source code. Although the subject matter of certain embodiments herein may have been described in language specific to structural features and/or methodological acts, it is to be understood that the subject matter of the present disclosure, is not limited to the described features or acts described herein, nor performance of the described acts by the components described herein. Rather, the described features and acts are disclosed as example forms of implementing the some aspects of the present disclosure.

In the description herein, various relational terms are provided to facilitate an understanding of various aspects of some embodiments of the present disclosure. Relational terms such as “bottom,” “below,” “top,” “above,” “back,” “front,” “left,” “right,” “rear,” “forward,” “up,” “down,” “horizontal,” “vertical,” “clockwise,” “counterclockwise,” “upper,” “lower,” “uphole,” “downhole,” and the like, may be used to describe various components, including their operation and/or illustrated position relative to one or more other components. Relational terms do not indicate a particular orientation for each embodiment within the scope of the description or claims. For example, a component of a BHA that is described as “below” another component may be further from the surface while within a vertical wellbore, but may have a different orientation during assembly, when removed from the wellbore, or in a deviated or other lateral borehole. Accordingly, relational descriptions are intended solely for convenience in facilitating reference to various components, but such relational aspects may be reversed, flipped, rotated, moved in space, placed in a diagonal orientation or position, placed horizontally or vertically, or similarly modified. Certain descriptions or designations of components as “first,” “second,” “third,” and the like may also be used to differentiate between identical components or between components which are similar in use, structure, or operation. Such language is not intended to limit a component to a singular designation. As such, a component referenced in the specification as the “first” component may be the same or different than a component that is referenced in the claims as a “first” component.

Furthermore, while the description or claims may refer to “an additional” or “other” element, feature, aspect, component, or the like, it does not preclude there being a single element, or more than one, of the additional or other element. Where the claims or description refer to “a” or “an” element, such reference is not be construed that there is just one of that element, but is instead to be inclusive of other components and understood as “at least one” of the element. It is to be understood that where the specification states that a component, feature, structure, function, or characteristic “may,” “might,” “can,” or “could” be included, that particular component, feature, structure, or characteristic is provided in some embodiments, but is optional for other embodiments of the present disclosure. The terms “couple,” “coupled,” “connect,” “connection,” “connected,” “in connection with,” and “connecting” refer to “in direct connection with,” or “in connection with via one or more intermediate elements or members.” Components that are “integral” or “integrally” formed include components made from the same piece of material, or sets of materials, such as by being commonly molded or cast from the same material, or machined from the same one or more pieces of material stock. Components that are “integral” should also be understood to be “coupled” together.

Any element described in relation to an embodiment herein may be combinable with any element (or any number of other elements) of any other embodiment(s) described herein. Although a few specific example embodiments have been described in detail herein, those skilled in the art will readily appreciate in view of the disclosure herein that many modifications to the example embodiments are possible without materially departing from the disclosure provided herein. Accordingly, such modifications are intended to be included in the scope of this disclosure. Likewise, while the disclosure herein contains many specifics, these specifics should not be construed as limiting the scope of the disclosure or of any of the appended claims, but merely as providing information pertinent to one or more specific embodiments that may fall within the scope of the disclosure and the appended claims. In addition, other embodiments of the present disclosure may also be devised which lie within the scopes of the disclosure and the appended claims. All additions, deletions, and modifications to the embodiments that fall within the meaning and scopes of the claims are to be embraced by the claims.

Certain embodiments and features may have been described using numerical examples, including sets of numerical upper limits and sets of numerical lower limits. It should be appreciated that ranges including the combination of any two values, are contemplated, or that any single value may be selected as a lower or upper value. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 10%, within 5%, within 1%, within 0.1%, or within 0.01% of a stated value.

A person having ordinary skill in the art should realize in view of the present disclosure that equivalent constructions do not depart from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

While embodiments disclosed herein may be used in oil, gas, or other hydrocarbon exploration or production environments, such environments are merely illustrative. Systems, interfaces, storage devices, computer-readable media, computer program products, and methods of simulating wellbore abandonment procedures, of the present disclosure may also be used in other applications and environments, including but not limited to automotive, aquatic, aerospace, hydroelectric, manufacturing, other industries, or even in other downhole environments. The terms “well,” “wellbore,” “borehole,” and the like are therefore also not intended to limit embodiments of the present disclosure to a particular industry. A wellbore or borehole may, for instance, be used for oil and gas production and exploration, water production and exploration, mining, utility line placement, or myriad other applications.

What is claimed is:

1. A computing system comprising:
one or more hardware processors; and
one or more storage devices having stored computer-executable instructions which, when executed by the one or more hardware processors, are configured to cause the computing system to:
access parameters of a virtual downhole casing environment and parameters of a virtual milling tool;
simulate an abandonment procedure by at least simulating an interaction of the virtual milling tool with the virtual downhole casing environment; and
render one or more visual outputs associated with the simulated abandonment procedure.

2. The computing system of claim 1, accessing parameters of a virtual downhole casing environment including the computing system presenting interactive elements at a simulation interface, the interactive elements being operable, in response to user input directed at the interactive elements, to define the parameters of the virtual downhole casing environment.

3. The computing system of claim 1, accessing parameters of a virtual downhole casing environment including the computing system accessing mesh simulation data defining at least a virtual state of one or more wellbores following a previous simulation of a downhole procedure involving the one or more wellbores.

4. The computing system of claim 1, accessing parameters of a virtual downhole casing environment including the computing system accessing one or more files having defined casing parameters.

5. The computing system of claim 1, the virtual downhole casing environment including a plurality of wellbore casing layers.

6. The computing system of claim 5, the plurality of wellbore casing layers including a plurality of casings that are at least partially nested.

7. The computing system of claim 1, the virtual downhole casing environment including at least one layer of cement.

8. The computing system of claim 7, the virtual downhole casing environment including a casing layer, a cement layer in an annulus around the casing layer, and earth formation surrounding the cement layer.

9. The computing system of claim 1, the virtual milling tool including at least one of a section mill, a casing mill, or a casing cutter.

10. The computing system of claim 1, simulating the abandonment procedure including simulating a section milling procedure.

11. The computing system of claim 1, the stored computer-executable instructions being configured to cause the computing system to simulate the abandonment procedure by performing a finite element analysis of at least the virtual milling tool with the virtual downhole casing environment.

12. The computing system of claim 1, the stored computer-executable instructions being configured to cause the computing system to render the one or more visual outputs by rendering an animation of the simulated abandonment procedure.

13. A computer program product comprising:
one or more computer hardware storage devices having stored computer-executable instructions which, when executed by one or more processors, cause a computing system having one or more processors, an interface engine, a visualization engine, and a simulation engine, to simulate a downhole abandonment procedure by at least:
utilizing the interface engine to generate an abandonment interface that displays interactive elements that, in response to user input directed at the interactive elements, selects, defines, or modifies one or more of milling tool parameters specifying characteristics of one or more virtual milling tools or wellbore casing parameters specifying characteristics of one or more virtual wellbore casings, the milling tool parameters and the wellbore casing parameters being stored in one or more files accessible to the interface engine;
in response to receiving the user input directed at the interactive elements, responsively selecting, defining, or modifying at least one of the milling tool parameters or the wellbore casing parameters;
utilizing the visualizing engine to generate a visual representation of the one or more virtual milling tools or the one or more virtual wellbore casings selected, defined, or modified by the user input;
utilizing the interface engine to select one or more abandonment simulation parameters, the one or more virtual milling tools, and the one or more virtual wellbore casings;
utilizing the simulation engine to perform a simulation of an abandonment procedure based on at least the abandonment simulation parameters and involving an interaction of the one or more virtual milling tools with the one or more virtual wellbore casings; and
rendering one or more visual outputs associated with the simulation of the abandonment procedure.

14. The computer program product of claim 13, utilizing the simulation engine to perform the simulation of the abandonment procedure including performing a finite element analysis on each of the selected one or more virtual abandonment milling tools and the selected one or more virtual wellbore casings.

15. The computer program product of claim 13, the one or more visual outputs reflecting at least one of a casing diameter, von Mises stress, vibration, bending moment, milling tool wear rate, milling tool deformation, casing material removal, cement material removal, earth formation removal, contact force, lateral acceleration, surface torque, mill axial acceleration, rate of penetration, downhole weight-on-bit, downhole rotational speed, or mill trajectory.

16. The computer program product of claim 13, the one or more virtual wellbore casings including at least a first virtual wellbore casing nested within a second virtual wellbore casing.

17. The computer program product of claim 13, the interaction of the one or more virtual milling tools with the one or more wellbore casings including an interaction of the one or more virtual milling tools with a virtual cement barrier positioned in an annulus between an inner virtual casing and either an outer virtual casing or an earth formation.

18. The computer program product of claim 13, the one or more virtual milling tools including at least one of a virtual casing mill or a virtual section mill.

19. The computer program product of claim 13, the simulation of the abandonment procedure including a virtual plugging procedure, the virtual plugging procedure including installing a plug at least partially in a wellbore region where at least a portion of the one or more virtual wellbore casings are removed by the one or more virtual milling tools.

20. A computer-implemented method performed by a computing system that includes one or more storage devices having stored computer-executable instructions which, when executed by one or more processors of the computing system, cause the computing system to perform an abandonment procedure simulation comprising:
generating an abandonment user interface that displays interactive elements that, in response to user input directed at the interactive elements, are operable for identifying BHA parameters of one or more virtual BHAs and wellbore parameters of one or more virtual wellbores;
in response to receiving the user input directed at the interactive elements, generating a visual representation of at least one of the one or more virtual BHAs or the one or more virtual wellbores;
identifying one or more abandonment simulation parameters that at least partially control an interaction between the one or more virtual BHAs and the one or more virtual wellbores during an abandonment procedure simulation;
simulating one or more abandonment procedures that involve an interaction between the one or more virtual BHAs and the one or more virtual wellbores, the interaction being at least partially controlled by the one or more abandonment simulation parameters; and
rendering one or more visual outputs associated with the simulated one or more abandonment procedures.
